(19) United States
(12) Patent Application Publication
(10) Pub. No.: US 2001/0010514 A1
(43) Pub. Date: Aug. 2, 2001

(54) Position detector and attitude detector

(76) Inventor: Yukinobu Ishino, Setagaya-ku (JP)

Correspondence Address: OLIFF & BERRIDGE, PLC, 277 S. WASHINGTON STREET, SUITE 500, ALEXANDRIA, VA, 22314, US

(21) Appl. No.: 09/797,829

(22) Filed: Mar. 5, 2001

Related U.S. Application Data
(63) Continuation-in-part of application No. 09/656,464, filed on Sep. 6, 2000.

(30) Foreign Application Priority Data
Mar. 7, 2000 (JP) 2000-067129
Sep. 7, 1999 (JP) 11-252732
Oct. 1, 1999 (JP) 11-281462
Jul. 19, 2000 (JP) 2000-218970
Jul. 19, 2000 (JP) 2000-218969

(51) Int. Cl. G09G 5/08

(52) U.S. Cl. 345/158

(57) ABSTRACT

A position of a target point on a given plane or an attitude of a given plane is to be detected. The given plane has a plurality of characteristic points, the number of which is greater than a predetermined number. The detector comprises an image sensor having an image plane on which an image of the given plane is formed with at least the predetermined number of the characteristic points included in the image. The position or the attitude is calculated on the basis of the identified positions of the predetermined number of the characteristic points on the image plane. A controller generates the characteristic points on the given plane. An image processor identifies the positions of the characteristic points with at least one of the characteristic points distinguished from the others. The image processor calculates a difference in the output of the image sensor between a first condition with the characteristic points on the given plane and a second condition with the given plane in a reference state. The identification of the positions of the characteristic points is caused by a trigger functioning with the image of the target point formed at the predetermined position of the image plane.

This application is a Continuation-in-Part from Ser. No.09/656,464.

This application is based upon and claims priority of Japanese Patent Applications No.11-252732 filed Sep. 7, 1999, No.11-281462 filed Oct. 1, 1999, No.2000-218970 filed Jul. 19, 2000, No.2000-218969 filed Jul. 19, 2000 and No.2000- 218970 filed Mar. 7, 2000, the contents being incorporated herein by reference.

### BACKGROUND OF THE INVENTION

1. Field of the Invention

The present invention relates to a detector for detecting a position of a target point or an attitude of a target object such as a plane.

2. Description of Related Art

In this field of the art, various types of detectors for a target point have been proposed for a presentation display controlled by a computer or for an amusement game.

For example, a Graphical User Interface on a wide screen display has been proposed for the purpose of a presentation or the like, in which a projector is connected to a computer for projecting a display image on a wide screen so that a number of audience may easily appreciate the presentation. In this case, a laser pointer or the like is prepared for pointing an object such as an icon or a text on the wide screen to input a command relating to the object pointed by the laser pointer.

In an amusement such as a shooting game, on the other hand, a scene including an object is presented on a cathode ray tube display of a game machine under a control of a computer. A user remote from the display tries to aim and shoot the object with a gun, and the game machine judges whether or not the object is successfully shot.

For the purpose of the above mentioned Graphical User Interface, it has been proposed to fixedly locate a CCD camera relative to the screen for detecting a bright spot on the wide screen caused by a laser beam to thereby detect the position of the bright spot on the screen.

It has been also proposed to prepare a plurality of light emitting elements on the screen in the vicinity of the projected image for the purpose of analyzing at a desired place the intensities and directions of light received from the light emitting elements to detect a position of a target on the screen.

and disadvantages still left in the related art, such as in However, there have been considerable problems seeking freedom or easiness in use, accuracy or speed in detection and size or cost in the practical product.

Laid-open Patent Application Nos. 2-306294, 3-176718, 4-305687, 6-308879, 9-231373 and 10-116341 disclose various attempts in this field of art.

In Japanese Laid-Open Patent Publications Nos. Hei 7-121293 and Hei 8-335136 are disclosed position detection devices that perform position detection by picking out mark images on a displayed image by the use of a camera. In Japanese Laid-Open Patent Publication No. Hei 7-121293 is disclosed a position detection device in which a maker is incorporated in each of predetermined frames in a displayed image, only the mark images are picked out by applying a differential image processing method to adjacent frames, and the position of a specified spot is detected based on the makers.

Further, in Japanese Laid-Open Patent Publication No. Hei 8-335136, whether the center of a image plane is in a displayed image is determined by means of mark images, and the size and position of a screen area in the taken image are calculated.

In Japanese Laid-Open Patent Publication No. Hei 7-261913 is disclosed a device that detects the position of a specified location by the use of a fixedly positioned camera. By the device, marks that are displayed at predetermined positions on a displayed image are taken by a camera, the positions of a plurality of marks in the image area are determined, position correcting information is generated from a plurality of the predetermined positions and from a corresponding plurality of the determined positions of the plurality of marks, and thus adverse influence of distortion resulting from the position of the camera and from the aberrations of the camera lens is reduced.

### SUMMARY OF THE INVENTION

In order to overcome the problems and disadvantages, the invention provides a position detector for detecting a position of a target point on a given plane having a plurality of characteristic points, the number of which is greater than a predetermined number. The position detector comprises an image sensor having an image plane on which an image of the given plane is formed with at least the predetermined number of the characteristic points included in the image, a point of the image which is formed at a predetermined position of the image plane corresponding to the target point to be located on the given plane. In the position detector, an image processor identifies the positions of the characteristic points on the image plane, and a processor calculates the position of the target point on the basis of the identified positions of the predetermined number of the characteristic points on the image plane.

The number of the characteristic points greater than the predetermined number is advantageous for the position detection in a wide area of the given plane since at least the predetermined number of characteristic points are formed on the image plane without fail for any part of the given plane.

According to another feature of the present invention, a controller is provided to generate the characteristic points on the given plane, the number of which is greater than the predetermined number.

According to still another feature of the present invention, the controller adds, to a display on the given plane, the plurality of characteristic points as a known standard. Or, the controller generates a first display and the plurality of characteristic points as a second display with the relative positions between both the displays predetermined. In the later case, a point in the image of the first display that is formed at a predetermined position of the image plane corresponds to target point. The processor, on the other hand, calculates the position of the target point on the basis of the position of the second display on the image plane identified by the image processor.

According to a further feature of the present invention, the image processor is arranged to identify the positions of the characteristic points on the image plane with at least one of the characteristic points distinguished from the others. More specifically, the processor includes a decider that decides a way of calculating the position of the target point among possible alternatives on the basis of the position of the at least one characteristic point distinguished from the others. This is advantageous to decide whether or not the positions of the characteristic points are inverted on the image plane.

According to a still further feature of the present invention, the image processor calculates a difference in the output of the image sensor between a first condition with the characteristic points on the given plane and a second condition with the given plane in a reference state. This is advantageous to surely identify the positions of the characteristic points.

According to another feature of the present invention, the image processor includes a trigger that causes the identification of the positions of the characteristic points with the image of the target point formed at the predetermined position of the image plane. More specifically, a controller is provided to generate the plurality of characteristic points on the given plane in synchronism with the trigger. This is advantageous to avoid disturbing the original display on the given plane with any meaningless appearance of the characteristic points.

The features of the present invention are applicable not only to the position detector, but also to an attitude detector for detecting an attitude of a given plane.

Other features and advantages according to the invention will be readily understood from the detailed description of the preferred embodiments in conjunction with the accompanying drawings.

### BRIEF DESCRIPTION OF THE DRAWINGS

FIG. 1 represents a perspective view of Embodiment 1 according to the present invention.

FIG. 2 represents a block diagrams of the main body of Embodiment 1.

FIG. 3 represents a detailed partial block diagram of FIG. 2.

FIG. 4 represents the perspective view of the main body.

FIG. 5 represents a cross sectional view of the optical system of main body in FIG. 4.

FIG. 6 represents a cross sectional view of a modification of the optical system.

FIG. 7 represents a flow chart for the basic function of Embodiment 1 according to the present invention.

FIG. 8 represents a flow chart of the manner of calculating the coordinate of the target point and corresponds to the details of step 106 in FIG. 7.

FIG. 9 represents an image taken by the main body, in which the image of target point is within the rectangular defined by the four characteristic points.

FIG. 10 represents another type of image taken by the main body, in which the image of target point is outside the rectangular defined by the four characteristic points.

FIG. 11 represents an image under the coordinate conversion from X-Y coordinate to X′-Y′ coordinate.

FIG. 12 represents a two-dimensional graph for explaining the basic relationship among various planes in the perspective projection conversion.

FIG. 13 represents a two-dimensional graph of only the equivalent image sensing plane and the equivalent rectangular plane with respect to the eye.

FIG. 14 represents a three-dimensional graph for explaining the spatial relationship between X-Y-Z coordinate representing the equivalent image sensing plane in a space and X*-Y* coordinate representing the given rectangular plane.

FIG. 15 represents a three-dimensional graph showing a half of the given rectangular plane with characteristic points Q1 and Q2.

FIG. 16 represents a two-dimensional graph of an orthogonal projection of the three-dimensional rectangular plane in FIG. 15 onto X′-Z′ plane.

FIG. 17 represents a two-dimensional graph of a orthogonal projection of the three-dimensional rectangular plane in FIG. 15 onto Y′-Z′ plane.

FIG. 18A represents a graph of U-V coordinate in which a point corresponding to characteristic point Q3 is set as origin O.

FIG. 18B represents a graph of X*-Y* coordinate in which Om is set as the origin.

FIG. 19 represents a perspective view of Embodiment 2 according to the present invention.

FIG. 20 represents a block diagram of the system concept for main body of Embodiment 2.

FIG. 21 represents a perspective view of the main body of Embodiment 2.

FIG. 22 represents a block diagram of personal computer to which the image data or command execution signal is transferred from the main body.

FIG. 23 represents a flow chart showing the operations of Embodiment 2 according to the present invention.

FIG. 24 represents a flow chart showing the operation of Embodiment 2 in the one-shot mode.

FIG. 25 represents a flow chart showing the operation of Embodiment 2 in the continuous mode.

FIG. 26 represents a perspective view of Embodiment 3

FIG. 27 represents a standard image for position detection.

FIG. 28 represents a flow chart of the characteristic point detector.

FIG. 29 represents the first example of the typical taking image.

FIG. 30 represents the second example of the typical taking image.

FIG. 31 represents a basic flow chart of the mark identification process.

FIG. 32 represents a flow chart of the R-colored mark identification process.

FIG. 33 represents a flow chart of the B-colored mark identification process.

FIG. 34 represents a flow chart of the E-colored mark identification process.

FIG. 35 represents a flow chart of the process by which whether the position to be detected is in the display image.

FIG. 36 represents the positional relationship between the marks displayed on the screen and the marks displayed on the personal computer as the original image.

### DETAILED DESCRIPTION OF THE PREFERRED EMBODIMENTS

[Embodiment 1]

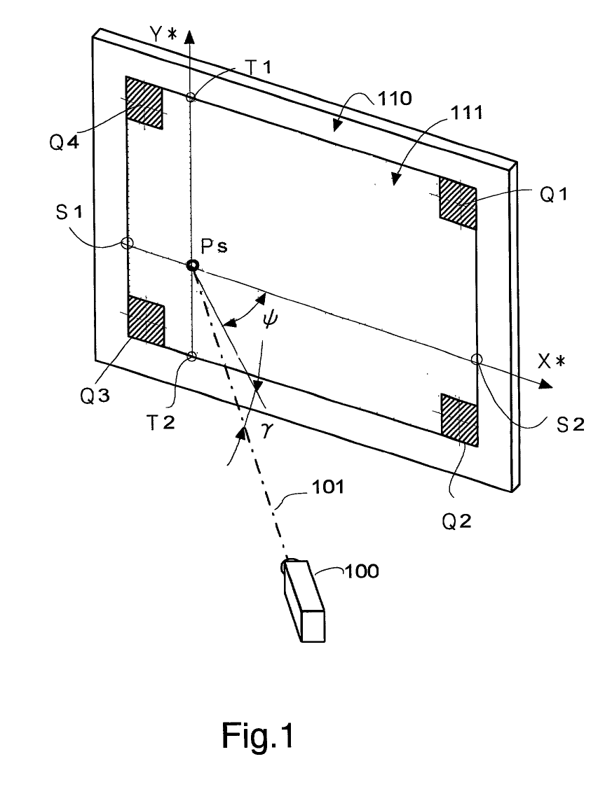

FIG. 1 represents a perspective view of Embodiment 1 showing the system concept of the position detecting device according to the present invention.

Main body 100 of Embodiment 1 is for detecting a coordinate of a target point Ps on a given rectangular plane 110 defined by characteristic points Q1, Q2, Q3 and Q4. Main body 100 may be handled at any desired position relative to plane 110. Broken line 101 is an optical axis of image sensing plane of camera 1 located within main body 100, the optical axis leading form the center of the image sensing plane perpendicularly thereto to target point Ps on plane 110.

The plane to be detected by Embodiment 1 is a rectangle appearing on an object or a figure such as a display of a monitor for a personal computer, a projected image on a screen, or a computer graphic image. The characteristic points according to the present invention may be the corners themselves of a rectangular image projected on a screen. Alternatively, the characteristic points may be projected within an image on the screen to define a new rectangular inside the image projected on the screen.

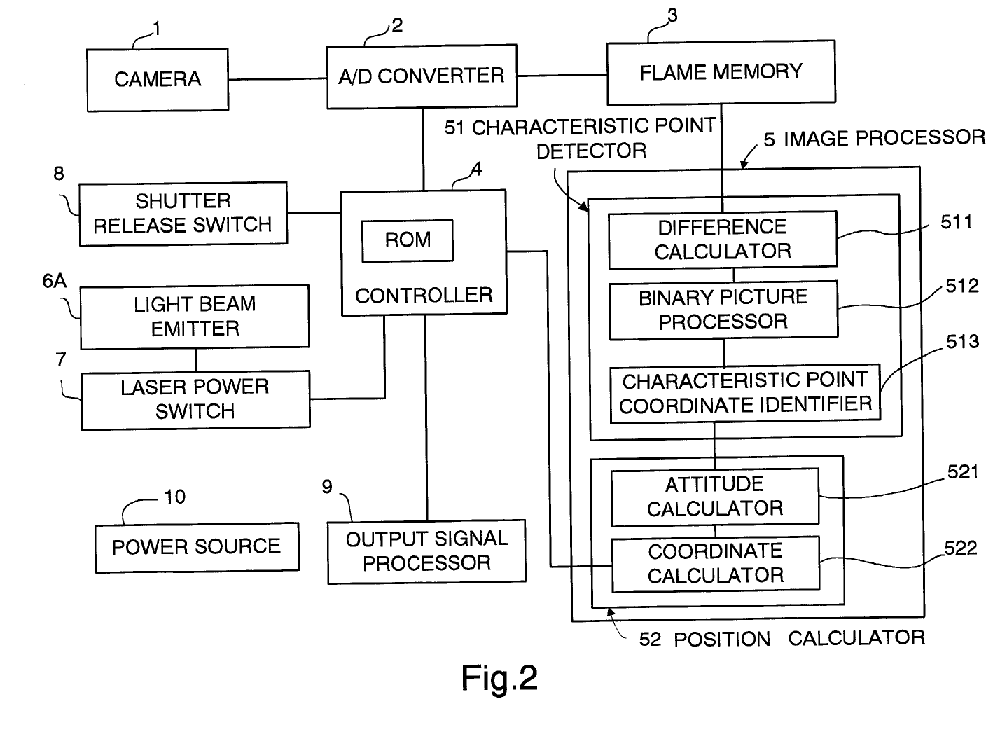

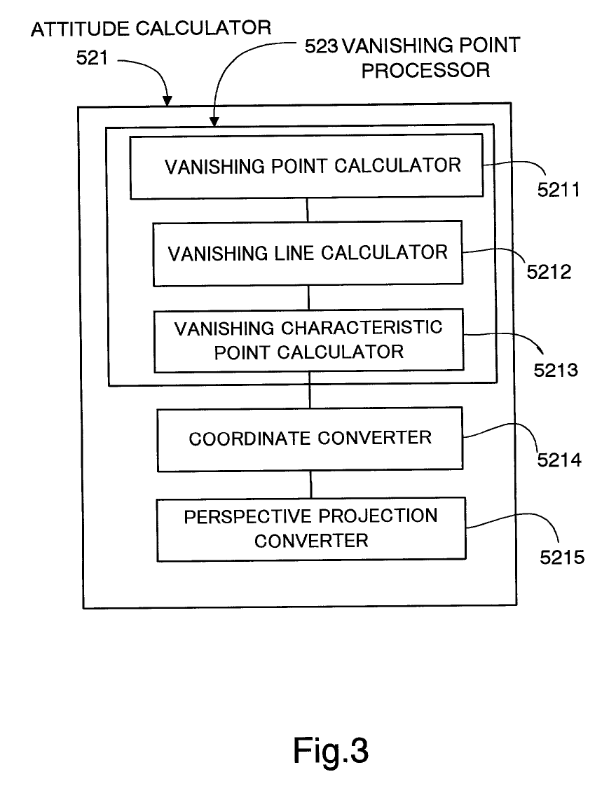

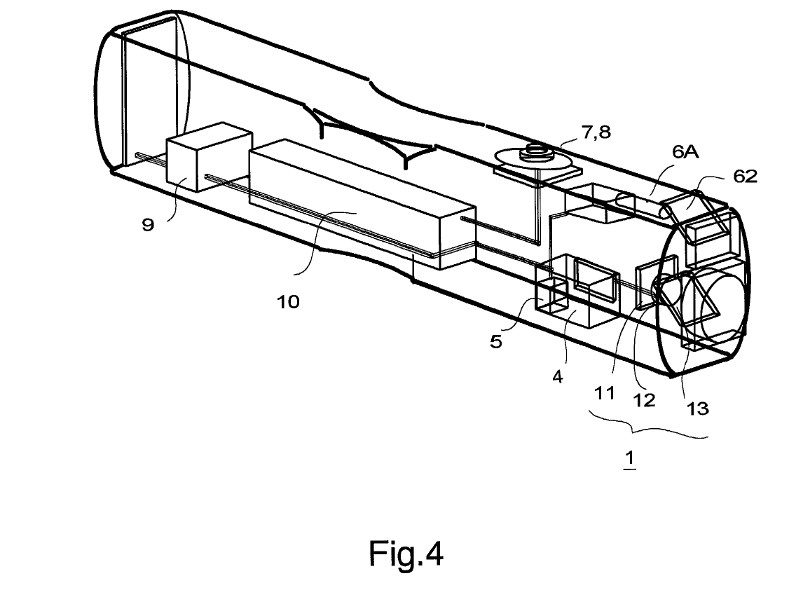

FIG. 2 shows the block diagrams of the main body 100, while FIG. 3 a detailed partial block diagram of FIG. 2. Further, FIG. 4 represents the perspective view of main body 100.

In FIG. 2, camera 1 includes a lens system and an image sensor. Camera 1 may be a digital still camera with CCD, or a video camera.

Camera 1 needs to define an aiming point for designating the target point Ps on plane 110. According to Embodiment 1, the aiming point is defined at the center of the image sensing plane as origin Om of image coordinate (X-Y coordinate). A/D converter 2 converts the image data taken by camera 1 into digital image data. Frame memory 3 temporally stores the digital image data at a plurality of addresses corresponding to the location of the pixels of CCD. Frame memory 3 is of a capacity of several ten megabytes (MS) for storing a plurality of images which will be taken successively.

Controller 4 includes Read Only Memory (ROM) storing a program for processing the perspective view calculation and a program for controlling other various functions. Image processor 5 includes characteristic point detector 51 and position calculator 52. Characteristic point detector 51 detects the characteristic points defining the rectangular plane in a space on the basis of the image data taken by camera 1, the detailed structure of characteristic point detector 51 being explained later. Position calculator 52 determines the position of the target point on the basis of the coordinate of the identified characteristic points.

Although not shown in the drawings, characteristic point detector 51 includes a detection checker for checking whether or not the characteristic points have been successfully detected from the digital image data temporally stored in frame memory 3 under the control of controller 4. By means of such a checker, an operator who has failed to take an image data sufficient to detect the characteristic points can be warned by a sound or the like to take a new image again.

Position calculator 52 includes attitude calculator 521 for calculating the rotational parameters of the given rectangular plane in a space (defined by X-Y-Z coordinate) relative to the image sensing plane and coordinate calculator 522 for calculating the coordinate of the target point on the rectangular plane.

FIG. 3 represents a detailed block diagram of attitude calculator 521, which includes vanishing point processor 523, coordinate converter 5214 and perspective projection converter 5215. Vanishing point processor 523 includes vanishing point calculator 5211, vanishing line calculator 5212 and vanishing characteristic point calculator 5213 for finally getting the vanishing characteristic points on the basis of the vanishing points calculated on the coordinate of the plurality of characteristic points on the image sensing plane. Perspective projection converter 5215 is for finally calculating the rotational parameters.

In FIG. 4, light beam emitter 6A made of semiconductor laser is a source of light beam to be transmitted toward the rectangular plane for visually pointing the target point on the plane such as in a conventional laser pointer used in a presentation or a meeting. As an alternative of light beam emitter 6A, a light emitting diode is available.

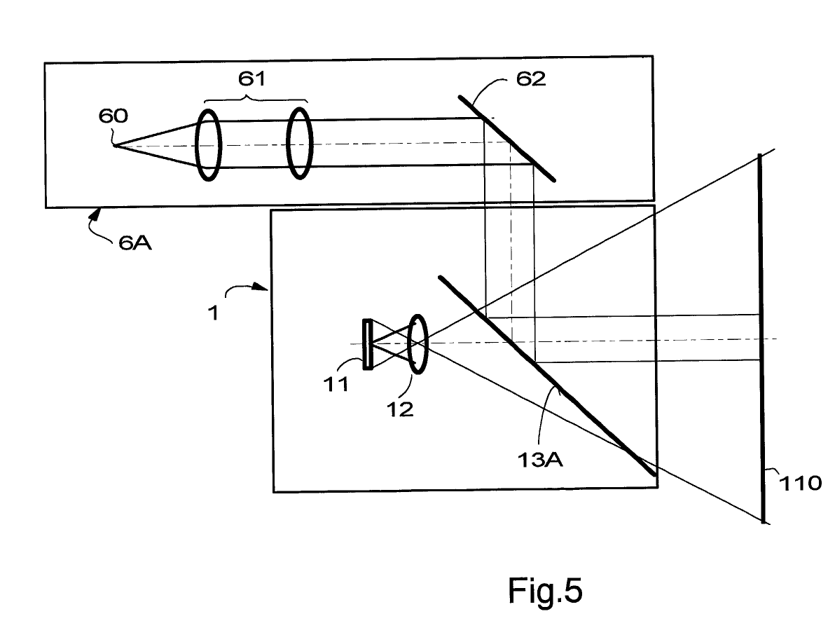

FIG. 5 shows a cross sectional view of the optical system of main body 100 in FIG. 4. If a power switch is made on, the laser beam is emitted at light source point 60 and collimated by collimator 61 to advance on the optical axis of camera 1 toward rectangular plane 110 by way of mirror 62 and semitransparent mirror 13A. Camera 1 includes objective lens 12 and CCD 11 for sensing image through semitransparent mirror 13A, the power switch of the laser being made off when the image is sensed by camera 1. Therefore, mirror 13A may alternatively be a full refractive mirror, which is retractable from the optical axis when the image is sensed by camera 1.

In this Embodiment 1, the position of beam emitter 6A is predetermined relatively to camera 1 so that the path of laser beam from beam emitter 6A coincides with the optical axis of camera 1. By this arrangement, a point on the rectangular plane 110 which is lit by the laser beam coincides with a predetermined point, such as the center, on the image sensing plane of CCD 11. Thus, if the image is sensed by camera 1 with the laser beam aimed at the target point, the target point is sensed at the predetermined point on the image sensing plane of CCD 11. The laser beam is only help for this purpose. Therefore, the position of light beam emitter 6A relative to camera 1 may alternatively predetermined so that the path of laser beam from beam emitter 6A runs in parallel with the optical axis of camera 1 with mirrors 62 and 13A removed. In this case, the difference between the path of laser beam and the optical axis of camera 1 can be corrected in the course of calculation. Or, the difference may be in some case negligible.

In FIG. 2, power switch 7 for light beam emitter 6A and shutter release switch 8 are controlled by a dual step button, in which power switch 7 is turned on with a depression of the dual step button to the first step. If the depression is quitted at the first step, power switch 7 is simply turned off. On the contrary, if the dual step button is further depressed to the second step, shutter release switch 8 is turned on to sense the image, the power switch 7 being turned off in the second step of the dual step button.

Output signal processor 9 converts the attitude data or the coordinate data calculated by position calculator 52 into output signal for displaying the output signal as a numeral data with the taken image on the main body or for forwarding the output signal to the peripheral apparatus, such as a video projector or a computer. By means of transmitting the output signal with a wireless signal transmitter adopted in output signal processor 9, the system will be still more conveniently used.

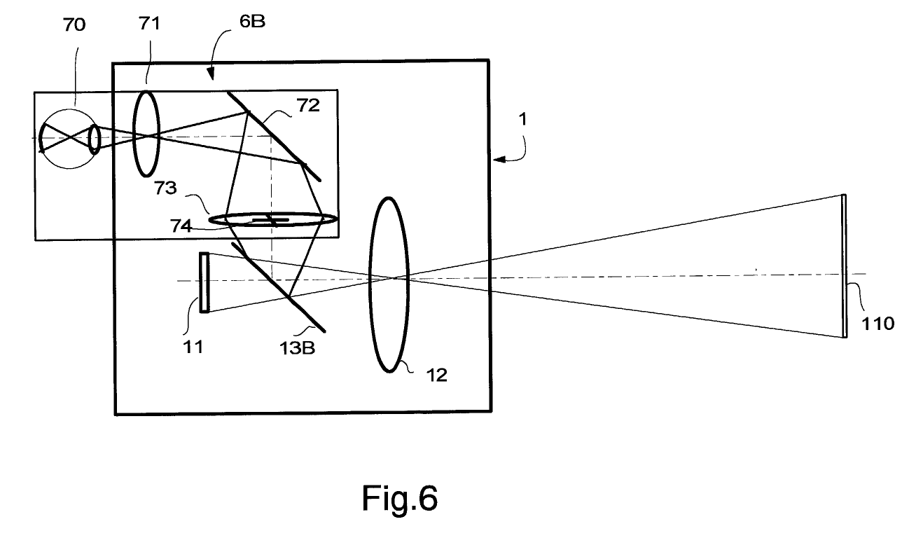

In FIG. 6, optical finder 6B is shown, which can replace light bean emitter 6A for the purpose of aiming the target point so that the target point is sensed at the predetermined point on the image sensing plane of CCD 11.

Optical finder 6B includes focal plane 73 which is made optically equivalent to the image sensing plane of CCD 11 by means of half mirror 13B. Cross 74 is positioned on focal plane 73, cross 74 being optically equivalent to the predetermined point on the image sensing plane of CCD 11. Human eye 70 observes both cross 74 and the image of rectangular plane 110 on focal plane 73 by way of eyepiece 71 and mirror 72. Thus, if the image is sensed by camera 1 with cross 74 located at the image of the target point on focal plane 73, the target point is sensed at the predetermined point on the image sensing plane of CCD 11.

If rectangular plane 110 is an image projected by a video projector controlled by a computer, for example, light beam emitter 6A or optical finder 6B may be omitted. In this case, the output signal is forwarded from the output signal processor 9 to the computer, and the calculated position is displayed on the screen as a cursor or the like under the control of the computer. Thus, the point which has been sensed at the predetermined point of the image sensing plane of CCD 11 is fed back to a user who is viewing the screen. Therefore, if the image taking, the calculation and the feed back displaying functions will be repeated successively, the user can finally locate the cursor at the target point on the screen.

Similarly, in the case that the given rectangular plane is a monitor of a personal computer, user can control the cursor on the monitor from any place remote form the computer by means of the system according to the present invention.

In Embodiment 1 above, camera 1 and image processor 5 are integrated as a one body as in FIG. 4. Image processor 5 may, however, be separated from camera 1, and be located as a software function in the memory of a peripheral device such as a computer.

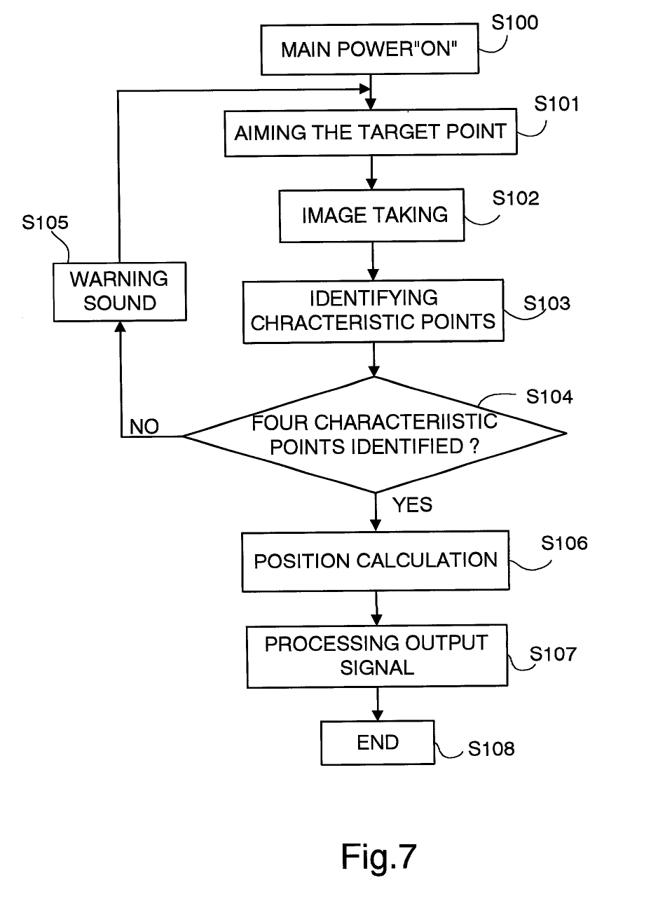

FIG. 7 represents a flow chart for the basic function of Embodiment 1 according to the present invention. In step S100, the main power of the system is turned on. In step S101, the target point on a given plane having the plurality of characteristic points is aimed so that the target point is sensed at the predetermined point on the image sensing plane of CCD 11. According to Embodiment 1, the predetermined point is specifically the center of image sensing plane of CCD 11 at which the optical axis of the objective lens of camera 1 intersects.

In step 102, the image is taken in response to shutter switch 8 of the camera 1 with the image of the target point at the predetermined point on the image sensing plane of CCD 11, then the image signal being stored in the frame memory by way of necessary signal processing following the image taking function.

In step S103, the characteristic points defining the rectangular plane are identified, each of the characteristic points being the center of gravity of each of predetermined marks, respectively. The characteristic points are represented by coordinate q1, q2, q3 and q4 on the basis of image sensing plane coordinate. In step 104, it is tested whether the desired four characteristic points are successfully and accurately identified. If the answer is “No”, a warning sound is generated in step S105 to prompt the user to take an image again. On the other hand, if the answer is “Yes”, the flow advances to step S106.

Step S106 is for processing the rotational parameters of the given rectangular plane in a space relative to the image sensing plane and the coordinate of the target point on the rectangular plane, which will be explained later in detail. In step S107, the calculated data is converted into output signal for display (not shown) or transmission to the peripheral apparatus. Then, the flow will be ended in step S108.

Now, the description will be advanced to the detailed functions of image processor 5 of Embodiment 1.

(A) Characteristic Point Detection

Various types of characteristic point detector are possible according to the present invention.

For example, in the case that the given rectangular plane is an image projected on a screen by a projector, the characteristic points are the four corners Q1, Q2, Q3 and Q4 of a rectangular image projected on a screen as in FIG. 1. The image is to taken with all the four corners covered within the image sensing plain of the camera. For the purpose of detecting the corners without fail in various situations, the projector is arranged to alternately projects a bright and dark images and the camera is released twice in synchronism with the alternation to take the bright and dark images Thus, the corners are detected by the difference between the bright and dark images to finally get the binary picture. According to Embodiment 1 in FIG. 2, characteristic point detector 51 includes difference calculator 511, binary picture processor 512 and characteristic point coordinate identifier 513 for this purpose.

Alternatively, at least four marks may be projected within an image on the screen to define a new rectangular inside the image projected on the screen, each of the characteristic points being calculated as the center of gravity of each of marks. Also in this case, the projector is arranged to alternately projects two images with and without the marks, and the camera is released twice in synchronism with the alternation to take the two images. Thus, the marks are detected by the difference between the two images to finally get the binary picture.

The characteristic points may be detected by an edge detection method or a pattern matching method. In the pattern matching method, the reference image data may previously stored in memory of the system to be compared with a taken image.

(B) Position Calculation

Position calculator calculates a coordinate of a target point Ps on a given rectangular plane defined by characteristic points, the given rectangular plane being located in a space.

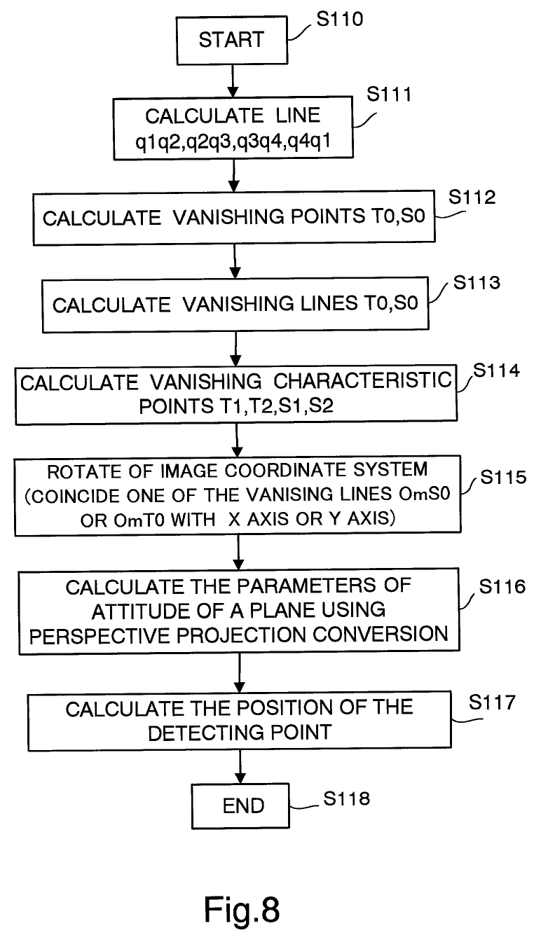

FIG. 8 show the manner of calculating the coordinate of the target point and corresponds to the details of step 106 in FIG. 7.

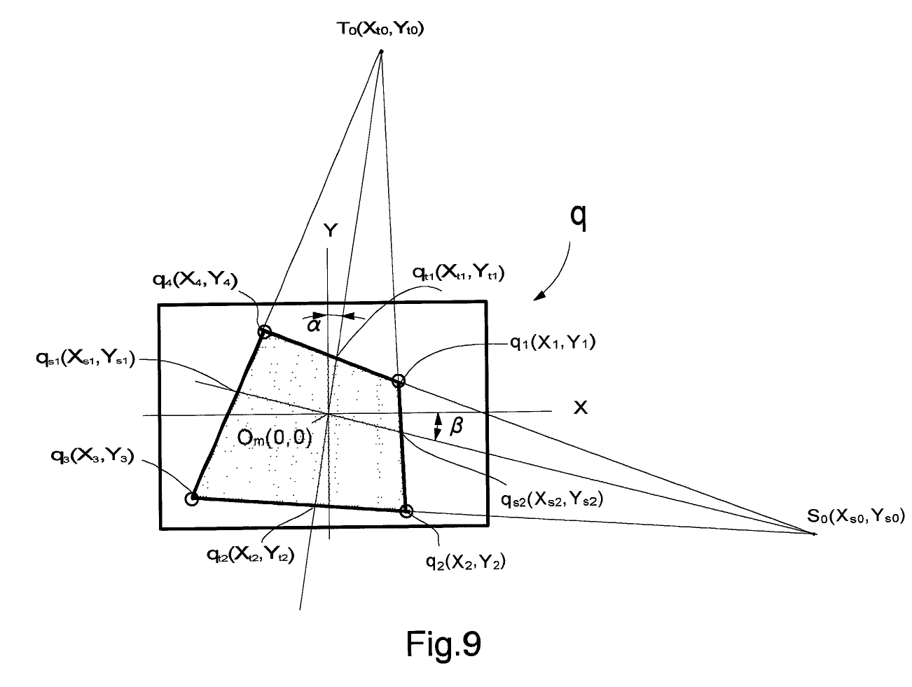

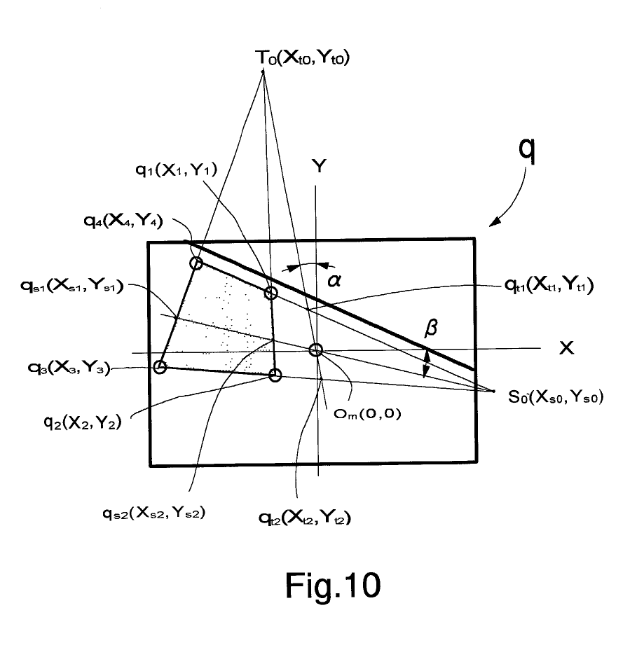

FIGS. 9 and 10 represent two types of image q taken by main body 100 from different position relative to the rectangular plane, respectively. In FIGS. 9 and 10, the image of target point Ps is in coincidence with predetermined point Om, which is the origin of the image coordinate. Characteristic points q1, q2, q3 and q4 are the images on the image sensing plane of the original of characteristic points Q1, Q2, Q3 and Q4 on the rectangular plane represented by X*-Y* coordinate.

In FIG. 9, the image of target point at predetermined point Om is within the rectangular defined by the four characteristic points q1, q2, q3 and q4, while the image of target point at predetermined point Om is outside the rectangular defined by the four characteristic points q1, q2, q3 and q4 in FIG. 10.

(b1) Attitude Calculation

Now, the attitude calculation, which is the first step of position calculation, is to be explained in conjugation with the flow chart in FIG. 8, the block diagram in FIG. 3 and image graphs in FIGS. 9 to 11. The parameters for defining the attitude of the given plane with respect to the image sensing plane are rotation angle γ around X-axis, rotation angle ψ around Y-axis, and rotation angle α or β around Z-axis.

Referring to FIG. 8, linear equations for lines q1q2, q2q3, q3q4 and q4q1 are calculated on the basis of coordinates for detected characteristic points q1, q2, q3 and q4 in step Sill, lines q1q2, q2q3, q3q4 and q4q1 being defined between neighboring pairs among characteristic points q1, q2, q3 and q4, respectively. In step S112, vanishing points T0 and S0 are calculated on the basis of the liner equations. Steps 111 and 112 correspond to the function of vanishing point calculator 5211 of the block diagram in FIG. 3.

The vanishing points defined above exists in the image without fail if a rectangular plane is taken by a camera. The vanishing point is a converging point of lines. If lines q1q2 and q3q4 are completely parallel with each other, the vanishing point exists in infinity.

According to Embodiment 1, the plane located in a space is a rectangular having two pairs of parallel lines, which cause two vanishing points on the image sensing plane, one vanishing point approximately on the direction along the X-axis, and the other along the Y-axis.

In FIG. 9, the vanishing point approximately on the direction along the X-axis is denoted with S0, and the other along the Y-axis with T0. Vanishing point T0 is an intersection of lines q1q2 and q3q4.

In step S113, linear vanishing lines OmS0 and OmT0, which are defined between vanishing points and origin Om, are calculated. This function in Step 113 corresponds to the function of vanishing line calculator 5212 of the block diagram in FIG. 3.

Further in step S113, vanishing characteristic points qs1, qs2, qt1 and qt2, which are intersections between vanishing lines OmS0 and OmT0 and lines q3q4, q1q2, q4q1 and q2q3, respectively, are calculated. This function in Step 113 corresponds to the function of vanishing characteristic point calculator 5213 of the block diagram in FIG. 3.

The coordinates of the vanishing characteristic points are denoted with qs1(Xs1, Ys1), qs2(Xs2, Ys2), qt1(Xt1, Yt1) and qt2(Xt2, Yt2). Line qt1qt2 and qs1qs2 defined between the vanishing characteristic points, respectively, will be called vanishing lines as well as OmS0 and OmT0.

Vanishing lines qt1qt2 and qs1qs2 are necessary to calculate target point Ps on the given rectangular plane. In other words, vanishing characteristic points qt1, qt2, qs1 and qs2 on the image coordinate (X-Y coordinate) correspond to points T1, T2, S1 and S2 on the plane coordinate (X*-Y* coordinate) in FIG. 1, respectively.

If the vanishing point is detected in infinity along X-axis of the image coordinate in step S112, the vanishing line is considered to be in parallel with X-axis.

In step 114, image coordinate (X-Y coordinate) is converted into X′-Y′ coordinate by rotating the coordinate by angle β around origin Om so that X-axis coincides with vanishing line OmS0. Alternatively, image coordinate (X-Y coordinate) may be converted into X″-Y″ coordinate by rotating the coordinate by angle α around origin Om so that Y-axis coincides with vanishing line OmT0. Only one of the coordinate conversions is necessary according to Embodiment 1. (Step S114 corresponds to the function of coordinate converter 5214 in FIG. 3.)

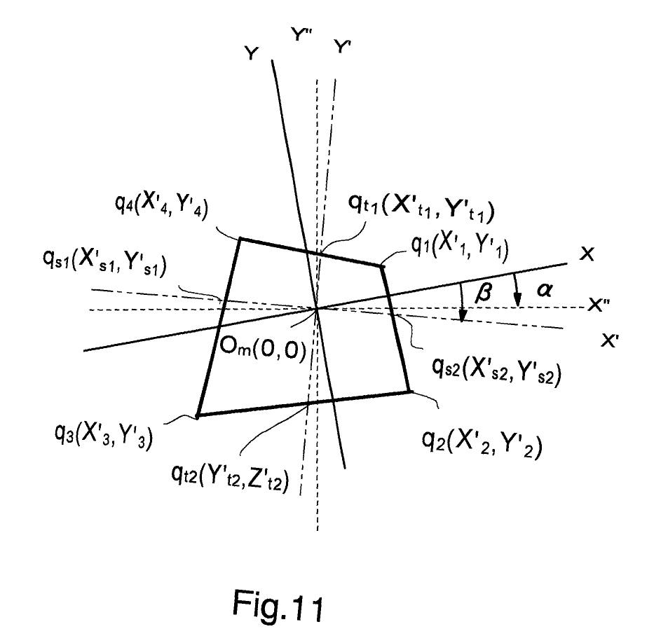

FIG. 11 is to explain the coordinate conversion from X-Y coordinate to X′-Y′ coordinate by rotation by angle β around origin Om with the clockwise direction is positive. FIG. 11 also explains the alternative case of coordinate conversion from X-Y coordinate to X″-Y″ coordinate by rotating the coordinate by angle α.

The coordinate conversion corresponds to a rotation around Z-axis of a space (X-Y-Z coordinate) to determine one of the parameters defining the attitude of the given rectangular in the space.

By means of the coincidence of vanishing line qs1qs2 with X-axis, lines Q1Q2 and Q3Q4 are made in parallel with X-axis.

In step S115, characteristic points q1, q2, q3 and q4 and vanishing characteristic points qt1, qt2, qt3 and qt4 on the new image coordinate (X′-Y′ coordinate) are related to characteristic points Q1, Q2, Q3 and Q4 and points T1, T2, S1 and S2 on the plane coordinate (X*-Y* coordinate). This is performed by perspective projection conversion according to the geometry. By means of the perspective projection conversion, the attitude of the given rectangular plane in the space (X-Y-Z coordinate) on the basis of the image sensing plane is calculated. In other words, the pair of parameters, angle ψ around Y-axis and angle γ around X-axis for defining the attitude of the given rectangular plane are calculated. The perspective projection conversion will be discussed in detail in the following subsection (b11). (Step S115 corresponds to the function of perspective projection converter 5215 in FIG. 3.)

In step S116, the coordinate of target point Ps on the plane coordinate (X*-Y* coordinate) is calculated on the basis of the parameters gotten in step S115. The details of the calculation to get the coordinate of target point Ps will be discussed later in section (b2).

(b11) Perspective Projection Conversion

Perspective projection conversion is for calculating the parameters (angles ψ and angle γ) for defining the attitude of the given rectangular plane relative to the image sensing plane on the basis of the four characteristic points identified on image coordinate (X-Y coordinate).

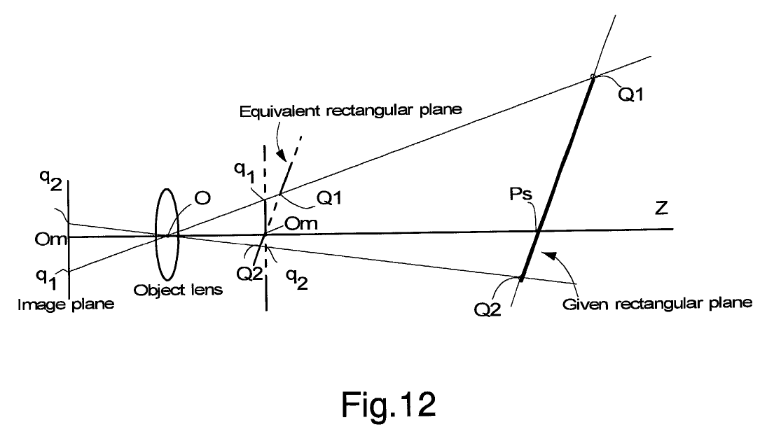

FIG. 12 explains the basic relationship among various planes in the perspective projection conversion, the relationship being shown in two-dimensional manner for the purpose of simplification. According to FIG. 12, a real image of the given rectangular plane is formed on the image sensing plane by the objective lens of the camera. The equivalent image sensing plane denoted by a chain line is shown on the object side of the objective lens at the same distance from the objective lens as that of the image sensing plane form the objective lens, the origin Om and points q1 and q2 being also used in the X-Y coordinate of the equivalent image sensing plane denoted by the chain line. The equivalent rectangular plane denoted by a chain line is also set by shifting the given rectangular plane toward the object side so that target point Ps coincides with the origin Om with the equivalent rectangular plane kept in parallel with the given rectangular plane. The points Q1 and Q2 are also used in the equivalent rectangular plane. In this manner, the relationship between the image sensing plane and the given rectangular plane are viewed at origin Om of the equivalent image sensing plane as if viewed from the center O of the objective lens, which is the view point of the perspective projection conversion.

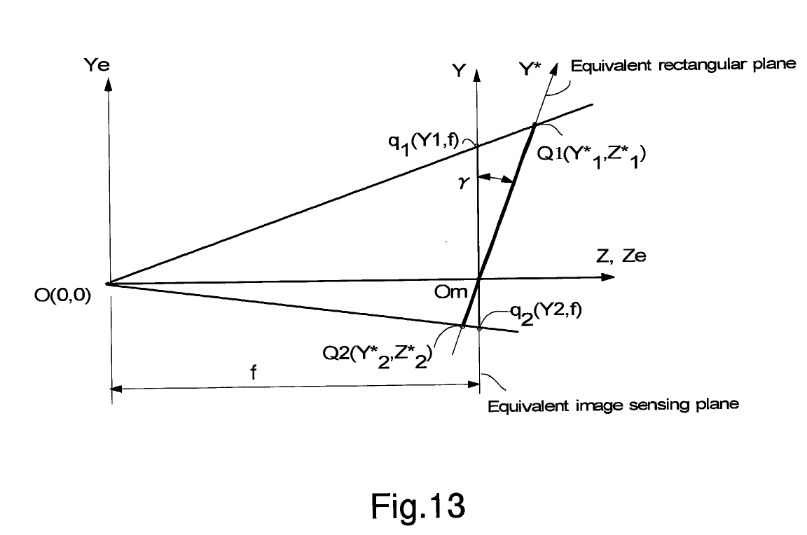

FIG. 13 shows only the equivalent image sensing plane and the equivalent rectangular plane with respect to view point O. The relationship is shown on the basis of Ye-Ze coordinate with its origin defined at view point O, in which the equivalent image sensing plane on X-Y coordinate and the given rectangular plane on X*-Y* coordinate are shown, Z-axis of the equivalent image sensing plane being in coincidence with Ze-axis. View point O is apart from origin Om of the image coordinate by f, which is equal to the distance from the objective lens to the image sensing plane. Further, the given rectangular plane is inclined by angle γ.

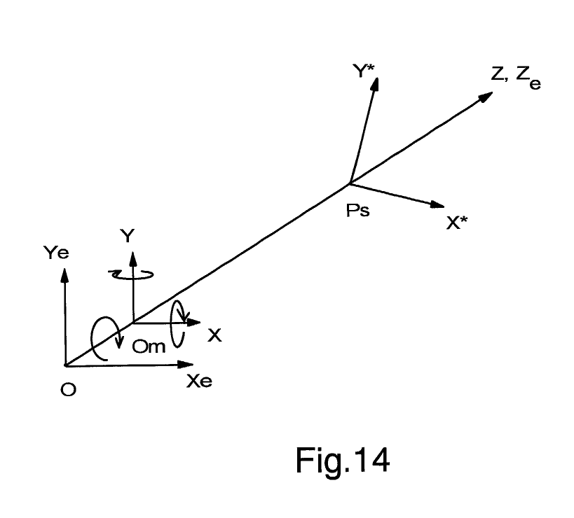

FIG. 14 is an explanation of the spatial relationship between X-Y-Z coordinate (hereinafter referred to as “image coordinate”) representing the equivalent image sensing plane in a space and X*-Y* coordinate (hereinafter referred to as “plane coordinate”) representing the given rectangular plane. Z-axis of image coordinate intersects the center of the equivalent image sensing plain perpendicularly thereto and coincides with the optical axis of the objective lens. View point O for the perspective projection conversion is on Z-axis apart from origin Om of the image coordinate by f. Rotation angle γ around X-axis, rotation angle ψ around Y-axis, and two rotation angles α and β both around Z-axis are defined with respect to the image coordinate, the clockwise direction being positive for all the rotation angles. With respect to view point O, Xe-Ye-Ze coordinate is set for perspective projection conversion, Ze-axis being coincident with Z-axis and Xe-axis and Ye-axis being in parallel with which will X-axis and Y-axis, respectively.

Now the perspective projection conversion will be described in detail. According to the geometry on FIG. 13, the relationship between Ye-Ze coordinate of a point such as Q1 on the equivalent rectangular plane and that of a point such as q1 on the equivalent image sensing plane, the points Q1 and q1 being viewed in just the same direction from view point O, can be generally expressed by the following equations (1) and (2)

$$\begin{matrix}{Y}^{*} = \frac{Y \cdot f}{f - Y tan γ} & ( 1 ) \\ {Z}^{*} = \frac{{f}^{2}}{f - Y tan γ} & ( 2 )\end{matrix}$$

Therefore, characteristic points Qi(Y*i, Z*i), wherein i is an integer, will be given by the following equations (3) and (4)

$$\begin{matrix}{Q}_{1} ( {Y}_{1}^{*} , {Z}_{1}^{*} ) = [ \frac{{Y}_{1} \cdot f}{f - {Y}_{1} tan γ} , \frac{{f}^{2}}{f - {Y}_{1} tan γ} ] & ( 3 ) \\ {Q}_{2} ( {Y}_{2}^{*} , {Z}_{2}^{*} ) = [ \frac{{Y}_{2} \cdot f}{f - {Y}_{2} tan γ} , \frac{{f}^{2}}{f - {Y}_{2} tan γ} ] & ( 4 )\end{matrix}$$

FIG. 14 shows the perspective projection conversion in three-dimensional manner for calculating the attitude of the rectangular plane given in a space (X-Y-Z coordinate) relative to the image sensing plane. Hereinafter the equivalent image sensing plane and the equivalent rectangular plane will be simply referred to as “image sensing plane” and “given rectangular plane”, respectively.

The given rectangular plane is rotated around Z-axis, which is equal to Z′-axis, by angle β in FIG. 14 so that Y′-axis is made in parallel with Ye-axis not shown.

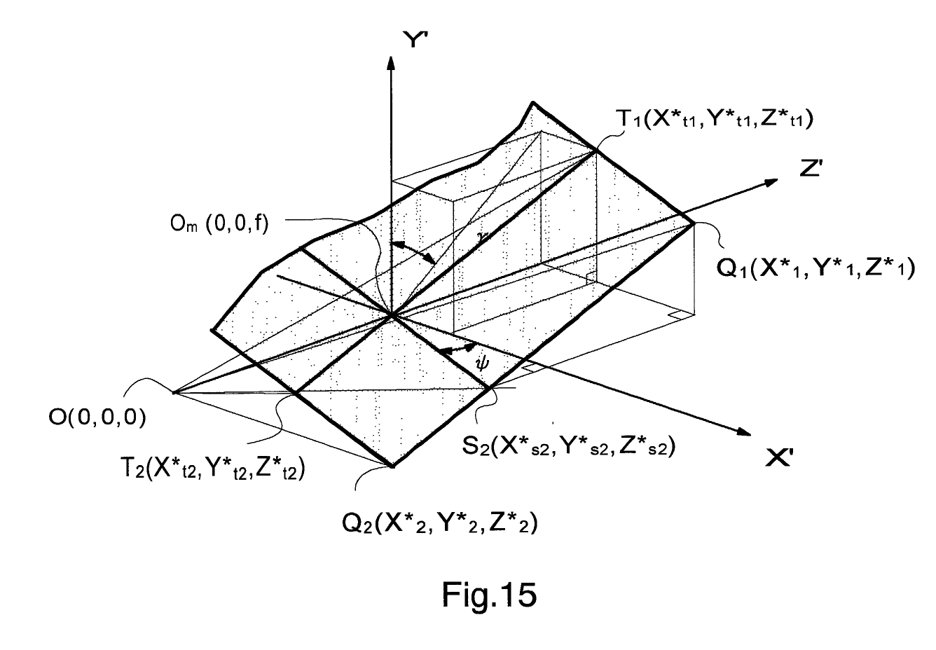

In FIG. 15, a half of the given rectangular plane is shown with characteristic points Q1(X*1, Y*1, Z*1) and Q2(X*2, Y*2, Z*2). Points T1(X*t1, Y*t1, Z*t1), T2(X*t2, Y*t2, Z*t2)and S2(X*s2, Y*s2, Z*s2) are also shown in FIG. 15. The remaining half of the given rectangular plane and the points such as Q3, Q4 and S1 are omitted from FIG. 15. Further, there are shown in FIG. 15 origin Om(0, 0, f) coincident with target point Ps and view point O(0, 0, 0), which is the origin of Xe-Ye-Ze coordinate.

Line T1Om is on Y′-Z′ plane and rotated by angel γ around X′-axis, while line S2Om is on X′-Z′ plane and rotated by angel ψ around Y′-axis, the clockwise directions of rotation being positive, respectively. The coordinates of Q1, Q2, T1, T2 and S2 can be calculated on the basis of the coordinates of q1, q2, qt1, qt2 and qs2 through the perspective projection conversion.

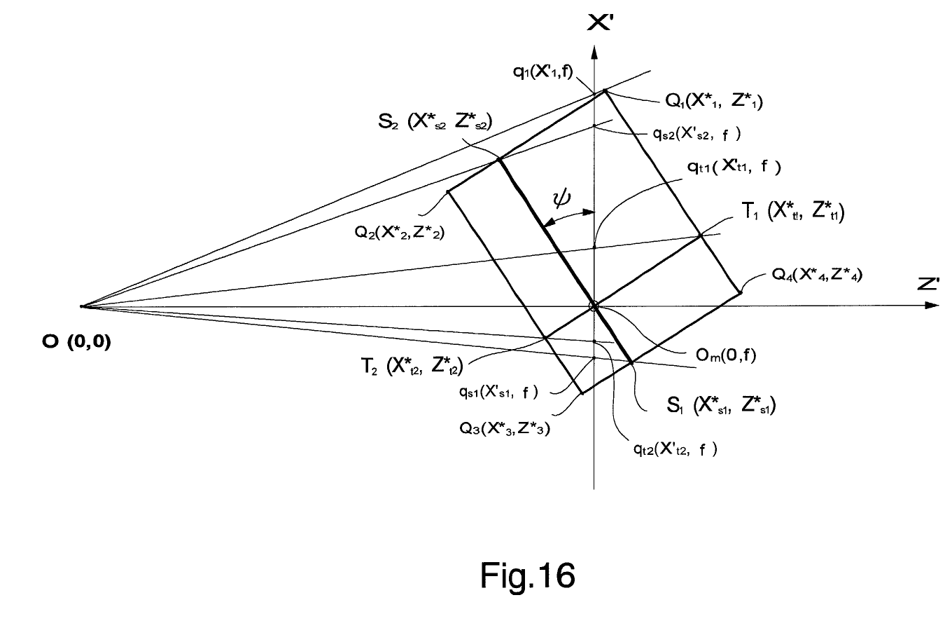

FIG. 16 represents a two-dimensional graph showing an orthogonal projection of the three-dimensional rectangular plane in FIG. 15 onto X′-Z′ plane in which Y′=0. In FIG. 16, only line S1S2 denoted by the thick line is really on X′-Z′ plane, while the other lines on the rectangular plane are on the X′-Z′ plane through the orthogonal projection.

According to FIG. 16, the X′-Z′ coordinates of T1(X*t1, Z*t1), T2(X*t2, Z*t2), S1(X*s1, Z*s1), S2(X*s2, Z*s2) and Q1(X*1, Z*1) can be geometrically calculated on the basis of the X′-Z′ coordinates of qt1(X′t1, f), qt2(X′t2, f), qs1(X′s1, f), qs2(X′s2, f) and q1(X′1, f) and angle ψ as in the following equations (5) to (9):

$$\begin{matrix}{T}_{1} ( {X}_{t1}^{*} , {Z}_{t1}^{*} ) = [ \frac{{X}_{t1}^{′} \cdot f \cdot tan ϕ}{f \cdot tan ϕ - {X}_{t1}^{′}} , \frac{{f}^{2} \cdot tan ϕ}{f \cdot tan ϕ - {X}_{t1}^{′}} ] & ( 5 ) \\ {T}_{2} ( {X}_{t2}^{*} , {Z}_{t2}^{*} ) = [ \frac{{X}_{t2}^{′} \cdot f \cdot tan ϕ}{f \cdot tan ϕ - {X}_{t2}^{′}} , \frac{{f}^{2} \cdot tan ϕ}{f \cdot tan ϕ - {X}_{t2}^{′}} ] & ( 6 ) \\ {S}_{1} ( {X}_{s1}^{*} , {Z}_{s1}^{*} ) = [ \frac{f \cdot {X}_{s1}^{′}}{{X}_{s1}^{′} \cdot tan ϕ + f} , \frac{{f}^{2}}{{X}_{s1}^{′} \cdot tan ϕ + f} ] & ( 7 ) \\ {S}_{2} ( {X}_{s2}^{*} , {Z}_{s2}^{*} ) = [ \frac{f \cdot {X}_{s2}^{′}}{{X}_{s2}^{′} \cdot tan ϕ + f} , \frac{{f}^{2}}{{X}_{s2}^{′} \cdot tan ϕ + f} ] & ( 8 ) \\ {Q}_{1} ( {X}_{1}^{*} , {Z}_{1}^{*} ) = [ \frac{{X}_{1}^{′} f \cdot tan ϕ - {X}_{s2}^{′}}{{X}_{s2}^{′} f \cdot tan ϕ - {X}_{1}^{′}} \cdot {X}_{s2}^{*} , \frac{f}{{X}_{s2}^{′}} \cdot \frac{f \cdot tan ϕ - {X}_{s2}^{′}}{f \cdot tan ϕ - {X}_{1}^{′}} \cdot {X}_{s2}^{*} ] & ( 9 )\end{matrix}$$

For the purpose of the following discussion, only one of X′-Z′ coordinates of the characteristic points Q1 to Q4 is necessary. Equation (9) for Q1 may be replaced by a similar equation for any one of characteristic points Q2 to Q4.

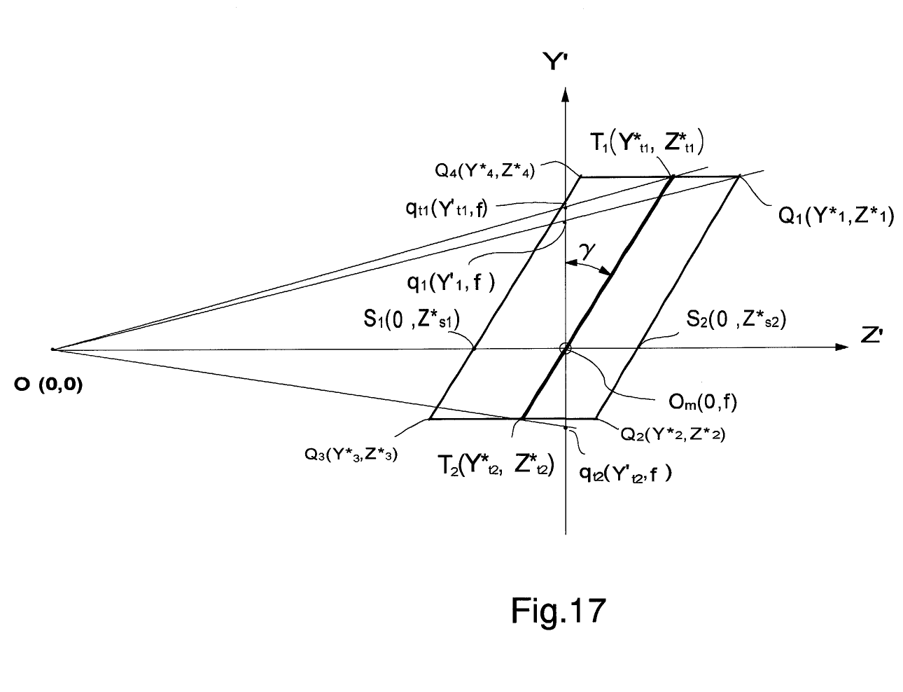

On the other hand, FIG. 17 represents a orthogonal projection of the three-dimensional rectangular plane onto Y′-Z′ plane in which X′=0. In FIG. 17, only line T1T2 denoted by the thick line is really on Y′-Z′ plane, while the other lines on the rectangular plane are on the Y′-Z′ plane through the orthogonal projection.

According to FIG. 17, the Y′-Z′ coordinates of T1(Y*t1, Z*t1), T2(Y*t2, Z*t2), S1(0, Z*s1), S2(0, Z*s2) and Q1(Y*1, Z*1) can be geometrically calculated on the basis of the Y′-Z′ coordinates of qt1(Y′t1, f), qt2(Y′t2, f), qs1(Y′s1, f), qs2(Y′s2, f) and q1(Y′1, f) and angle γ as in the following equations (5) to (9):

$$\begin{matrix}{T}_{1} ( {Y}_{t1}^{*} , {Z}_{t1}^{*} ) = [ \frac{{Y}_{t1}^{′} \cdot f}{f - {Y}_{t1}^{′} tan γ} , \frac{{f}^{2}}{f - {Y}_{t1}^{′} tan γ} ] & ( 10 ) \\ {T}_{2} ( {Y}_{t2}^{*} , {Z}_{t2}^{*} ) = [ \frac{{Y}_{t2}^{′} \cdot f}{f - {Y}_{t2}^{′} tan γ} , \frac{{f}^{2}}{f - {Y}_{t2}^{′} tan γ} ] & ( 11 ) \\ {S}_{1} ( {Y}_{s1}^{*} , {Z}_{s1}^{*} ) = [ 0 , \frac{{f}^{2} \cdot tan γ}{{Y}_{s1}^{′} + f \cdot tan γ} ] & ( 12 ) \\ {S}_{2} ( {Y}_{s2}^{*} , {Z}_{s2}^{*} ) = [ 0 , \frac{{f}^{2} \cdot tan γ}{{Y}_{s2}^{′} + f \cdot tan γ} ] & ( 13 ) \\ {Q}_{1} ( {Y}_{1}^{*} , {Z}_{1}^{*} ) = [ \frac{{Y}_{1}^{′}}{f - {Y}_{1}^{′} \cdot tan γ} \cdot {Z}_{s2}^{*} , \frac{f}{f - {Y}_{1}^{′} \cdot tan γ} \cdot {Z}_{s2}^{*} ] & ( 14 )\end{matrix}$$

The Y*-coordinate of S1 and S2 in equations (12) and (13) are zero since the X-Y coordinate is rotated around Z axis by angle β so that X-axis coincides with vanishing line S1S2, angle β being one of the parameters for defining the attitude of the given rectangular plane relative to the image sensing plane.

Since the Z*-coordinate of T1 in equation (5) is just the same as that in equation (10), the following equation (15) results:

$$\frac{{f}^{2}}{f - {Y}_{t1}^{′} \cdot tan γ} = \frac{{f}^{2} \cdot tan ϕ}{f \cdot tan ϕ - {X}_{t1}^{′}} \qquad ( 15 )$$

Similarly, the following equation (16) results from equations (9) and (14) both relating to the Z*-coordinate of Q1:

$$\frac{f}{f - {Y}_{1}^{′} \cdot tan γ} \cdot {Z}_{s2}^{*} = \frac{f}{{X}_{s2}^{′}} \cdot \frac{f \cdot tan ϕ - {X}_{s2}^{′}}{f \cdot tan ϕ - {X}_{1}^{′}} \cdot {X}_{s2}^{*} \qquad ( 16 )$$

Equation (15) can be simplified into the following equation (17):

$$tan γ = \frac{1}{tan ϕ} \cdot \frac{{X}_{t1}^{′}}{{Y}_{t1}^{′}} \qquad ( 17 )$$

And equation (15) can be modified into the following equation (18) by substituting X*s2 and Z*s2 with equation (8), and tan γ with equation (17):

$$tan ϕ = \frac{{X}_{t1}^{′} {X}_{s2}^{′} {Y}_{1}^{′}}{{X}_{t1}^{′} {Y}_{1}^{′} + {X}_{s2}^{′} {Y}_{t1}^{′} - {X}_{1}^{′} {Y}_{tf}^{′}} \cdot \frac{1}{f} \qquad ( 18 )$$

Equations (17) and (18) are conclusion of defining angles γ and ψ which are the other two of parameters for defining the attitude of the given rectangular plane relative to the image sensing plane. The value for tan γ given by equation (17) can be practically calculated by replacing tan ψ by the value calculated through equation (18). Thus, all of the three angles β, γ and ψ are obtainable.

As in equations (17) and (18), angles γ and ψ are expressed by the coordinate of characteristic point q1 (X′1, Y′1) and the coordinate of a vanishing characteristic points qt1(X′t1, Y′t1) and qs2(X′s2) which are calculated on the basis of the coordinates. Distance f in the equation is a known value. Thus, the attitude of the given rectangular plane relative to the image sensing plane can be uniquely determined by the positions of the characteristic points on the image plane.

According to present invention, any complex matrix conversion or the like is not necessary for calculating parameters of the attitude of the given rectangular plane, but such simple form of equations as equations (17) and (18) are sufficient for the same purpose. This leads to various advantages, such as a reduced burden on the calculating function, a less error or high accuracy in calculation and a low cost of the product.

Further, only condition necessary for the calculation according to the present invention is that the characteristic points on the given plane are required to define a rectangle. In other words, any specific information such as the aspect ratio of the rectangle or the relation among the coordinates of the corners of the rectangle is not necessary at all. Further, an information of the distance from the image sensing plane to the given plane is not necessary in the calculation according to the present invention.

Equations (19) and (20) are another forms of conclusion, in which the analysis is made with the counter clockwise rotation around Y-axis defined as positive direction for representing ψ on the contrary to equations (17) and (18):

$$\begin{matrix}tan γ = - \frac{1}{tan ϕ} \cdot \frac{{X}_{t1}^{′}}{{Y}_{t1}^{′}} & ( 19 ) \\ tan ϕ = \frac{{Y}_{1}^{′} - {Y}_{t1}^{′}}{{X}_{t1}^{′} {Y}_{1}^{′} - {X}_{1}^{′} {Y}_{t1}^{′}} \cdot f & ( 20 )\end{matrix}$$

In the case of equations (19) and (20), at least one coordinate of characteristic point q1 (X′1, Y′1), at least one coordinate of a vanishing characteristic point qt1(X′t1, Y′t1) and distance f are only necessary to get angles γ and ψ.

Equations (21) and (22) are still another forms of conclusion, in which the analysis is made with the X-Y coordinate rotated around Z axis by angle α so that Y-axis coincides with vanishing line T1T2 on the contrary to equations (17) and (18):

$$\begin{matrix}tan ϕ = \frac{1}{tan γ} \cdot \frac{{X}_{s2}^{″}}{{Y}_{s2}^{″}} & ( 21 ) \\ tan γ = \frac{{X}_{s2}^{″} - {X}_{1}^{″}}{{X}_{s2}^{″} {Y}_{1}^{″} - {X}_{t1}^{″} {Y}_{s2}^{″}} \cdot f & ( 22 )\end{matrix}$$

(b2) Coordinate Calculation

Now, the coordinate calculation for determining the coordinate of the target point on the given rectangular plane is to be explained. The position of target point Ps on given rectangular plane 110 with the plane coordinate (X*-Y* coordinate) in FIG. 1 is calculated by coordinate calculator 522 in FIG. 2 on the basis of the parameters for defining the attitude of the given rectangular plane obtained by attitude calculator 521.

Referring to FIG. 16, ratio m=OmS1/OmS2 represents the position of Om along the direction in parallel with that of Q3Q2, while ratio n=OmT1/OmT2 represents the position of Om along the direction in parallel with that of Q3Q4, which is perpendicular to Q3Q2. And, ratio m and ratio n can be expressed as in the following equations (23) and (24), respectively, in view of equations (5) to (8) in which coordinates of S1(X*s1, Z*s1), S2(X*s2, Z*s2), T1(X*t1, Z*t1) and T2(X*t2, Z*t2) are given by coordinates of qs1(X′s1, f) and qs2(X′s2, f), qt1(X′t1, f) and qt2(X′t2, f):

$$\begin{matrix}m = \frac{\overline{{O}_{m} {S}_{1}}}{\overline{{O}_{m} {S}_{2}}} = \frac{\vert {X}_{s1}^{′} \vert}{\vert {X}_{s2}^{′} \vert} \cdot \frac{\vert {X}_{s2}^{′} \cdot tan ϕ + f \vert}{\vert {X}_{s1}^{′} \cdot tan ϕ + f \vert} & ( 23 ) \\ n = \frac{\overline{{O}_{m} {T}_{1}}}{\overline{{O}_{m} {T}_{2}}} = \frac{\vert {X}_{t1}^{′} \vert}{\vert {X}_{t2}^{′} \vert} \cdot \frac{\vert f \cdot tan ϕ - {X}_{t2}^{′} \vert}{\vert f \cdot tan ϕ - {X}_{t1}^{′} \vert} & ( 24 )\end{matrix}$$

Equation (23) is given by the X′-coordinate of vanishing characteristic points qs1(X′s1) and qs2(X′s2), distance f and angle ψ, while equation (24) by the X′-coordinate of vanishing characteristic points qt1(X′t1), qt2(X′t2), distance f and angle ψ. With respect to angle ψ tan ψ is given by equation (18).

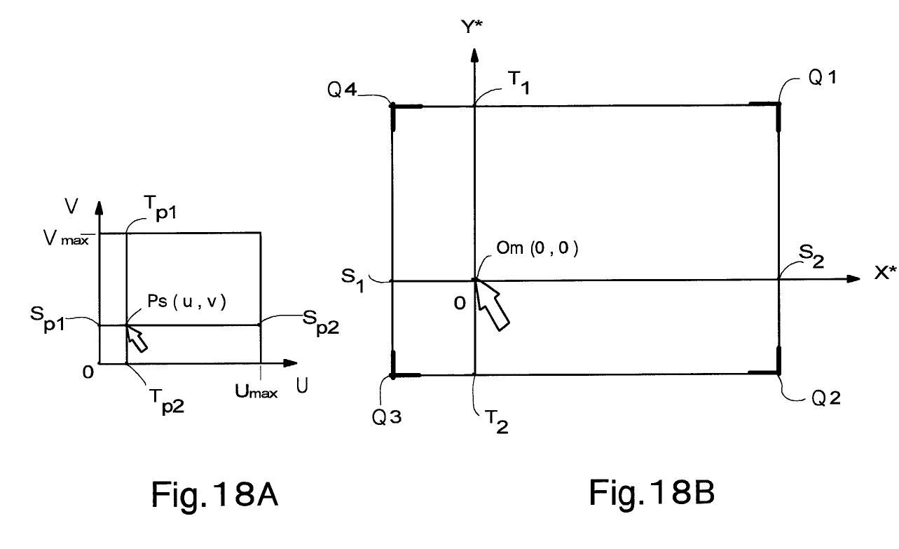

FIGS. 18A and 18B represent conversion from ratio m and ratio n to a coordinate of target point Ps in which characteristic point Q3 is set as the origin of the coordinate. In more detail, FIG. 18B is shown in accordance with X*-Y* coordinate in which Om(0, f), which is in coincidence with target point Ps, is set as the origin, while FIG. 18A shown in accordance with U-V coordinate in which a point corresponding to characteristic point Q3 is set as origin O. Further, characteristic points Q2 and Q4 in FIG. 18B correspond to Umax on U-axis and Vmax on V-axis, respectively, in FIG. 18A. According to FIG. 18A, coordinate of target point Ps(u, v) is given by the following equation (25):

$${P}_{s} ( u , v ) = ( \frac{m}{m + 1} \cdot {u}_{max} , \frac{n}{n + 1} \cdot {v}_{max} ) \qquad ( 25 )$$

Alternatively, FIG. 17 also gives the ratio m and n expressed by Y′-coordinate of vanishing characteristic points qs1(Y′s1), qs2(Y′s2), qt1(Y′t1) and qt2(Y′t2), distance f and angle γ as in the following equations (26) and (27):

$$\begin{matrix}m = \frac{\overline{{O}_{m} {S}_{1}}}{\overline{{O}_{m} {S}_{2}}} = \frac{\vert {Y}_{s1}^{′} \vert}{\vert {Y}_{s2}^{′} \vert} \cdot \frac{\vert {Y}_{s2}^{′} - f \cdot tan γ \vert}{\vert {Y}_{s1}^{′} - f \cdot tan γ \vert} & ( 26 ) \\ n = \frac{\overline{{O}_{m} {T}_{1}}}{\overline{{O}_{m} {T}_{2}}} = \frac{\vert {Y}_{t1}^{′} \vert}{\vert {Y}_{t2}^{′} \vert} \cdot \frac{\vert f - {Y}_{t2}^{′} \cdot tan γ \vert}{\vert f - {Y}_{t1}^{′} \cdot tan γ \vert} & ( 27 )\end{matrix}$$

Equations (26) and (27) are similarly useful to equations (23) and (24) to lead to equation (25).

[Simulation for Testifying the Accuracy]

The accuracy of detecting the position or attitude according to the principle of the present invention is testified by means of a simulation.

In the simulation, a rectangular plane of 100 inch size (1500 mm×2000 mm) is given, the four corners being the characteristic points, and the target point at the center of the rectangular plane, i.e., m=1, n=1. The attitude of the rectangular relative to the image sensing plane is given by angles, γ=5° and ψ=−60°. And, the distance between the target point and the center of the image sensing plane is 2000 mm. On the other hand, the distance f is 5 mm.

According to the above model, the coordinates of characteristic points on the image sensing plane are calculated by means of the ordinary perspective projection matrix. And the resultant coordinates are the base of the simulation.

The following table shows the result of the simulation, in which the attitude parameter, angles γ and ψ and the position parameter, ratio m and n are calculated by means of the equations according to the principle of the present invention. The values in the table prove the accuracy of the attitude and position detection according to the present invention.

ATTITUDE OF GIVEN RECTANGULAR PLANE RELATIVE TO IMAGE SENSING
PLANE vs. POSITION OF TARGET ON THE GIVEN RECTANGULAR PLANE

| | | Case of Rotation of Vanishing | Case of Rotation of Vanishing |
|---|---|---|---|
| | | line S1S2 by Angle α for | line T1T2 by Angle β for |
| | | Coincidence with X-axis | Coincidence with Y-axis |
| Parameters | α, β | −8.585 | 0.000 |
| of Attitude | tan ψ | −1.710 | −1.730 |
| | ψ | −59.687 | −59.967 |
| | tan γ | 0.088 | 0.087 |
| | γ | 5.044 | 4.988 |
| Position on | m | 0.996 | 0.996 |
| the plane | (= OmS1/ | | |
| | OmS2) | | |
| | n | 1.000 | 1.000 |
| | (= OmT1/ | | |
| | OmT2) | | |

[Embodiment 2]

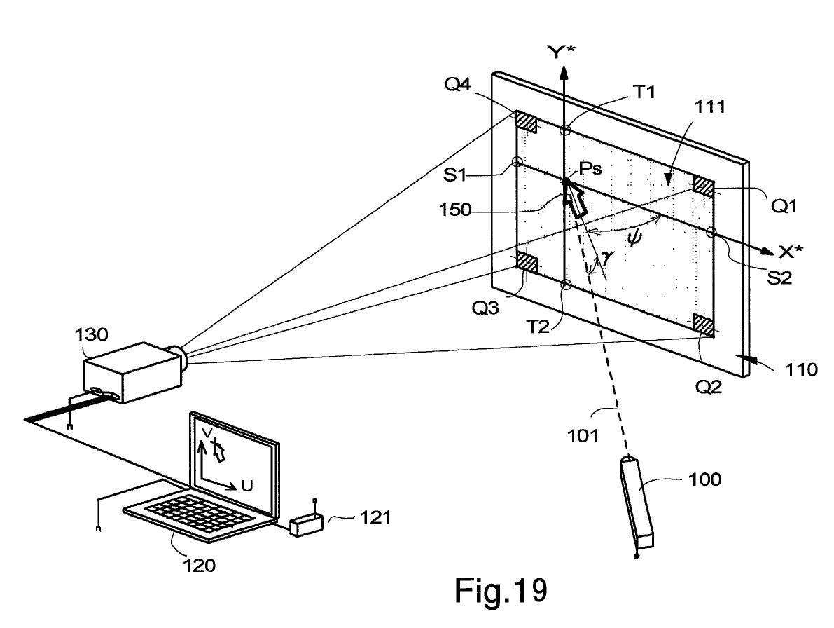

FIG. 19 represents a perspective view of Embodiment 2 according to the present invention. Embodiment 2 especially relates to a pointing device for controlling the cursor movement or the command execution on the image display of a personal computer. FIG. 19 shows the system concept of the pointing device and its method.

Embodiment 2 corresponds to a system of Graphical User Interface, while Embodiment 1 to a position detector, which realizes the basic function of Graphical User Interface. Thus, the function of Embodiment 1 is quite suitable to Graphical User Interface according to the present invention. The basic principle of Embodiment 1, however, is not only useful in Graphical User Interface, but also in detecting the position of a target point or the attitude of a three-dimensional object in general.

Further, the information of attitude detection according to the present invention is utilized by the position detection, and then by Graphical User Interface. In terms of the position detection or Graphical User Interface, the target point should be aimed for detection. However, any specific target point need not be aimed in the case of solely detecting the attitude of an object as long as the image of necessary characteristic points of the object are formed on the image sensing plane.

Referring back to Embodiment 2 in FIG. 19, 100 is a main body of the pointing device, 110 a given screen plane, 120 a personal computer (hereinafter referred to as PC), 121 a signal receiver for PC 120, and 130 a projector. Projector 130 projects display image 111 on screen plane 110. The four corners Q1, Q2, Q3 and Q4 of display image 111 are the characteristic points, which define the shape of display image 111, the shape being a rectangular. Main body 100 is for detecting coordinates of a target point Ps on screen plane 110 toward which cursor 150 is to be moved. An operator in any desired place relative to screen 110 can handle main body 100. Broken line 101 is the optical axis of the image sensing plane of camera 1 (not shown) located inside main body 100, broken line 101 leading from the center of the image sensing plane perpendicularly thereto to target point Ps on screen plane 110.

According to the Embodiment, the characteristic points correspond to the four corners of display image 111 projected on screen plane 110. However, the characteristic points may exist at any locations within screen plane 110. For example, some points of a geometric shape within display image 111 projected on screen plane 110 may act as the characteristic points. Alternatively, specially prepared characteristic points may be projected within screen plane 110. The characteristic points may not be independent points, but may be the intersection of two pairs of parallel lines which are perpendicular to each other. Further, the characteristic points may not be the projected images, but may be light emitting diodes prepared on screen plane 110 in the vicinity of the display image 111.

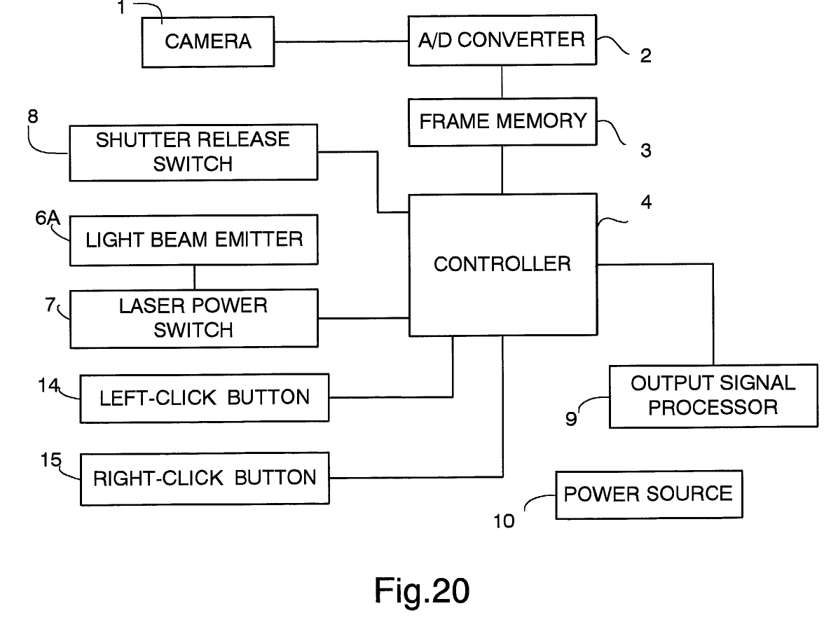

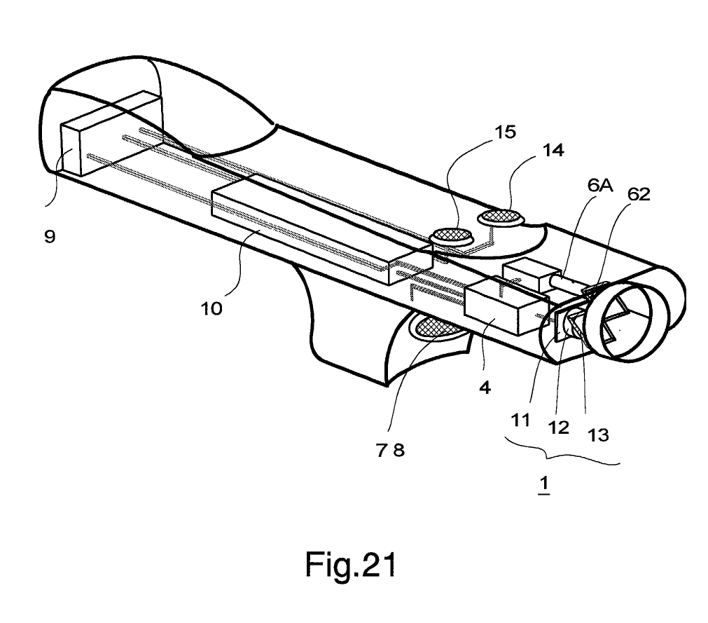

FIGS. 20 and 21 represent the block diagram and the perspective view of the system concept for main body 100, respectively. The configuration of main body 100 is basically same as Embodiment 1 in FIG. 2. However, left-click button 14 and right-click button 15 are added in FIGS. 20 and 21. Further, image processor 5 of FIG. 2 is incorporated in PC 120 in the case of FIGS. 20 and 21. Thus, main body 100 is provided with output signal processor 9 for transferring the image data to PC 120 by way of signal receiver 121.

The functions of left-click button 14 and right-click button 15 are similar to those of ordinary mouse, respectively. For example, left-click button 14 is single-clicked or double-clicked with the cursor at an object such as an icon, a graphics or a text to execute the command related to the object. A click of right-click button 15 causes PC 120 to display pop-up menu at the cursor position, just as the right-button click of the ordinary mouse does. The movement of the cursor is controlled by shutter release switch 8.

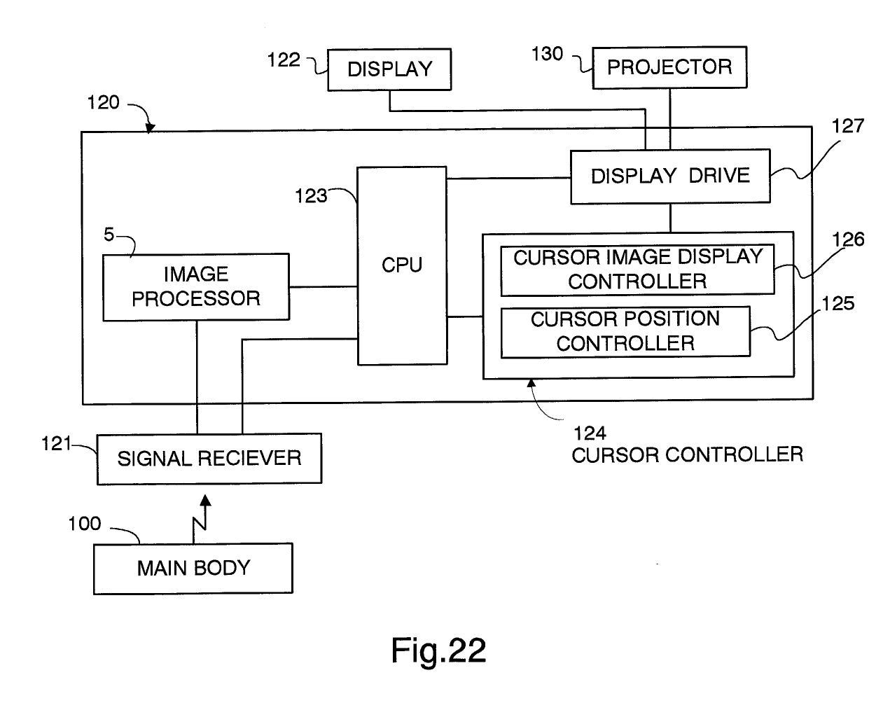

Now the block diagram of PC 120 to which the image data or command execution signal is transferred from the main body 100 will be described in conjunction with FIG. 22. The detailed explanation of image processor 5, which has been done in Embodiment 1, will be omitted.

PC 120 receives signals from main body 100 at signal receiver 121. Display 122 and projector 130 are connected to PC 120. Display 122, however, is not necessarily required in this case.

Image data transferred by main body 100 is processed by image processor 5 and is output to CPU 123 as the coordinate data of the target point. Cursor controller 124 which corresponds to an ordinary mouse driver controls the motion of the cursor. Cursor controller 124 consists of cursor position controller 125, which converts the coordinate data of the target point into a cursor position signal in the PC display system, and cursor image display controller 126, which controls the shape or color of the cursor. Cursor controller 124 may be practically an application program or a part of the OS (operating system) of PC 120.

Now, the operations of the pointing device of this embodiment will be described in detail. Basic operations of the pointing device are the position control of cursor and the command execution with the cursor at a desired position. The function of the pointing device will be described with respect to these basic operations.

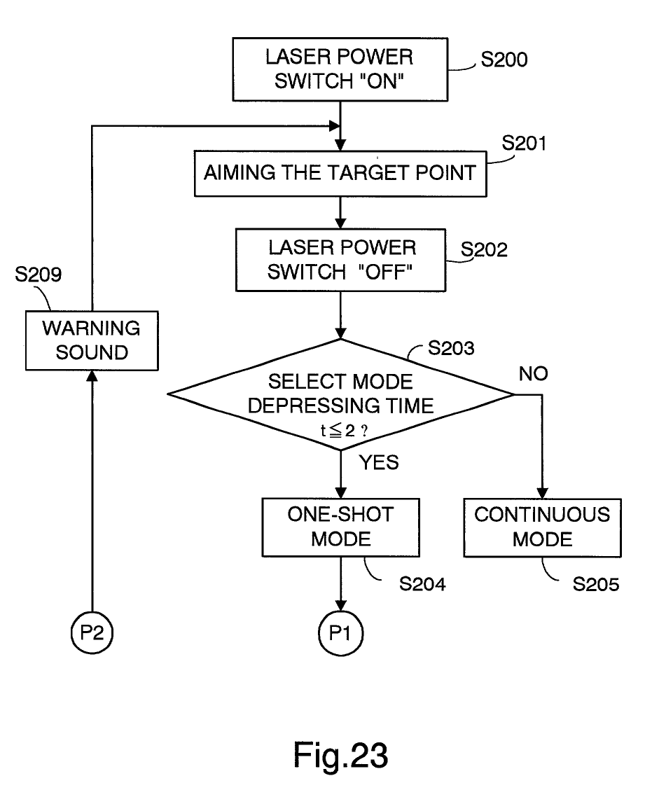

FIGS. 23, 24 and 25 represent flow charts for the above mentioned operations of the pointing device according to the present invention.

The operation of the pointing device for indicating the target point on the screen and moving the cursor toward the target point is caused by a dual-step button which controls both the shutter release switch 8 and the laser power switch 7. This operation corresponds to that of the ordinary mouse for moving the cursor toward a desired position.

Instep S200 in FIG. 23, the power source of laser power switch 7 is turned on by a depression of the dual-step button to the first step, which causes the emission of the infrared laser beam. The operator may point the beam at any desired point on the screen in the similar manner to that in the ordinary laser pointer.

In step S201, the operator aims the laser beam at the target point. Instep S202, the dual-step button is depressed to the second-step to make the laser power switch 7 off. Instep S203, it is discriminated whether the mode is an one-shot mode or a continuous mode according to the time duration of depressing the dual-step button to the second step. In this embodiment, a threshold of the time duration is set to two seconds. However, the threshold may be set at any desired duration. If the dual-step button is kept in the second step more than two seconds, it is discriminated that the mode is the continuous mode to select step S205. On the other hand, if the time duration is less than two seconds in step S203, the one-shot mode in S204 is selected.

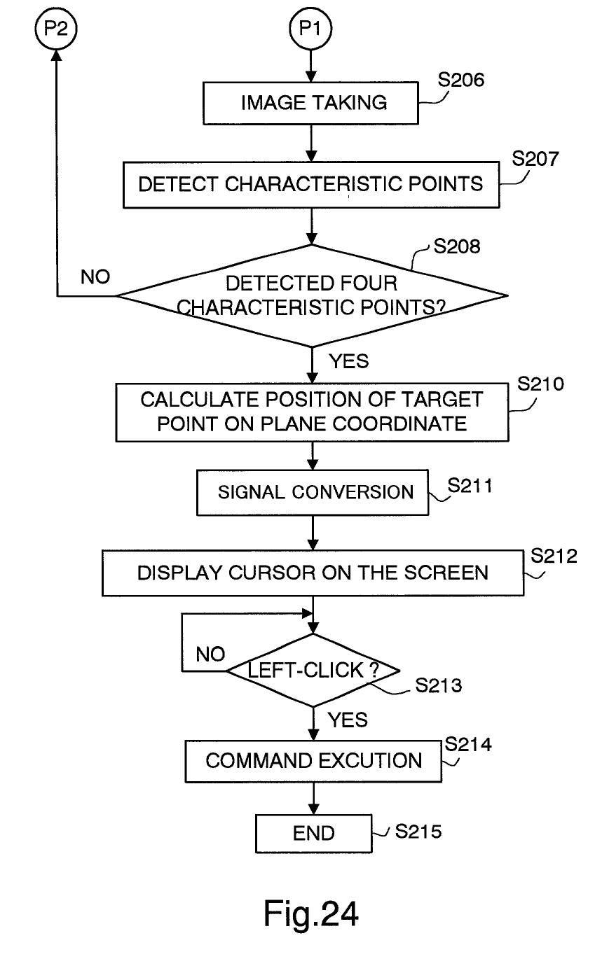

In the case of the one-shot mode, shutter release switch 8 is turned on to take the image in step S206 of FIG. 24. As steps S207 to S210 in FIG. 24 are the same as the basic flowchart in FIG. 7 described before, the explanation is omitted.

In step S211, the coordinate of the target point is converted into a cursor position signal in the PC display system and transferred to projector 130 by way of CPU 123 and display drive 127. In step S212, projector 130 superimposes the cursor image on the display image 111 at the target point Ps.

In this stage, the operator should decide whether or not to push left-click button 14. In other words, the operator would be willing to click the button if the cursor is successfully moved to the target point. On the other hand, if the desired cursor movement is failed, which would be caused by the depression of the dual-step button with the laser beam at an incorrect position, the operator will not click the button. Step 213 is for waiting for this decision by the operator. In the case of failure in moving the cursor to the desired position, the operator will depress the dual-step button again, and the flow will jump back to step S200 in FIG. 23 to restart the function. On the contrary, if the operator pushes left-click button 14, the flow is advanced to step S214 to execute the command relating to the object on which the cursor is positioned. The command execution signal caused by the left-click button 14 of main body 100 is transmitted to PC 120. Step S215 is the end of the command execution.

In step S212, the cursor on the screen stands still after being moved to the target point. In other words, cursor position controller 125 keeps the once-determined cursor position signal unless shutter release switch 8 is turned on again in the one-shot mode. Therefore, left-click button 14 can be pushed to execute the command independently of the orientation of main body 100 itself if the cursor has been successfully moved to the desired position.

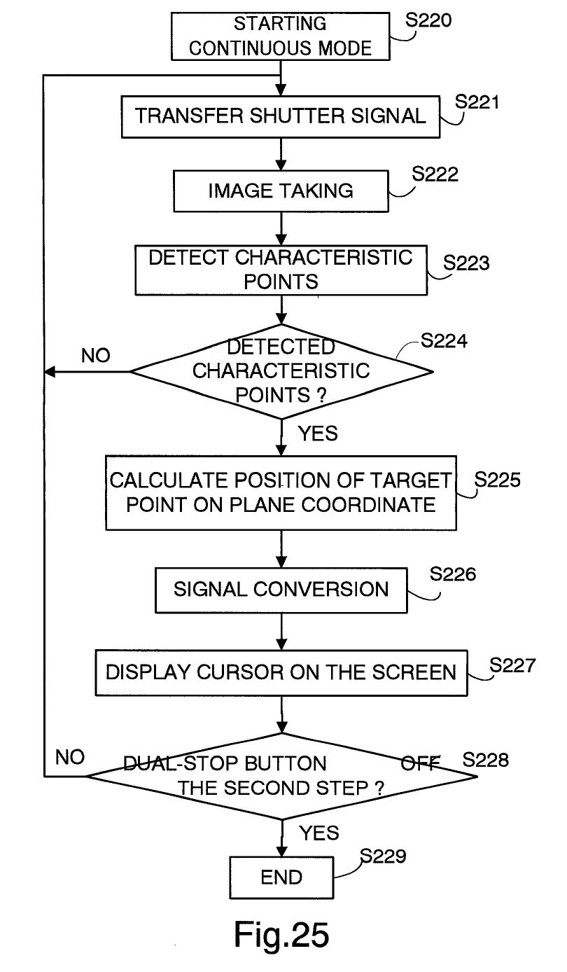

FIG. 25 is a flow chart for explaining the continuous mode, which corresponds to the details of step S205 in FIG. 23. In step 221, shutter release switch 8 is turned on to take the image. In the continuous mode, a train of clock pulses generated by the controller 4 at a predetermined interval governs shutter release switch 8. This interval stands for the interval of a step-by-step movement of the cursor in the continuous mode. In other words, the shorter the interval is, the smoother is the continuous movement of the cursor. The set up of this interval is possible even during the operation by a set up dial or the like (not shown).

Shutter release button 8 is once turned on at every pulse in the train of the clock pulses in Step 221. And, Steps 221 to 227 are completed prior to the next pulse generated, and the next pulse is waited for in Step 221. Thus, Steps 221 to 227 are cyclically repeated at the predetermined interval to cause the continuous movement of the cursor.

The repetition of Steps 221 to 227 continues until the dual-step button is made off the second step. Step 227 is for terminating the continuous mode with the dual-step button made off the second step.

According to a modification of the embodiment, the cyclic repetition of Steps 221 to 227 may be automatically controlled depending on the orientation of the main body 100. In other words, the train of clock pulses is intermitted not to turn on shutter release button 8 in step S221 when the laser beam is outside the area of display image 111, and is generated again when the laser beam comes back inside the area.

Although not shown in the flow in FIG. 25, left-click button 14 may be pushed at any desired time to execute a desired command. Further, if main body 100 is moved with left-click button 14 kept depressed along with dual-step button depressed to the second step, an object in display image 111 can be dragged along with the movement of the cursor.

As described above, the cursor control and the command execution of the embodiment according to the present invention can be conveniently practiced as in the ordinary mouse.

In summary referring back to FIG. 22, the image data taken by the main body 100 with the target point aimed with the laser beam is transmitted to PC 120. In PC 120, the image data is received at signal receiver 121 and transferred to input/output interface (not shown), which processes the image data and transfers the result to image processor 5. With the image processor 5, characteristic points are detected on the basis of the image data to calculate their coordinates. The coordinates of the characteristic points are processed to calculate the coordinate of the target point, which is transferred to cursor position controller 125 to move the cursor. CPU 123 controls those functions. The resultant cursor position corresponds to that of the target point on the screen. Main body also transmits the command execution signal to PC 120 with reference to the position of the cursor.

In more detail, position controller converts the information of the target point given in accordance with the X*-Y* coordinate as in FIG. 18B into a cursor controlling information given in accordance with the U-V coordinate as in FIG. 18A.

CPU 123 activates a cursor control driver in response to an interruption signal at input/output interface to transmit a cursor control signal to display drive 127. Such a cursor control signal is transferred from display drive 127 to projector 130 to superimpose the image of cursor on the display image.

On the other hand, the command execution signal transmitted from main body executes the command depending on the position of the cursor in accordance with the OS or an application of CPU.

The small and light wait pointing device according to the present invention needs not any mouse pad or the like as in the ordinary mouse, but can be operated in a free space, which greatly increases a freedom of operation. Besides, an easy remote control of PC is possible with a desired object image on a screen plane pointed by an operator himself.

Further, the pointing device according to the present invention may be applied to a gun of a shooting game in such a manner that a target in an image projected on a wide screen is to be aimed and shot by the pointing device as a gun.

Now, a coordinate detection of a target point in an image projected with a distortion on a screen plane will be described.

In a case of projecting an original of true rectangle to a screen plane with the optical axis of the projector perpendicular to the screen plane, the projected image would also be of a true rectangle provided that the optical system of the projector is free from aberrations.

On the contrary, if the original of true rectangle is projected on the screen plane inclined with respect to the optical axis of the projector, an image of a distorted quadrangle would be caused on the screen plane. The main body takes the distorted quadrangle on the screen plane with the optical axis of the main body inclined with respect to the screen plane to cause a further distorted quadrangle on the image sensing plane of the main body.

According to the principle of the present invention, however, the calculations are made on the assumption that the image on the screen plane is of a true rectangle. This means that the distorted quadrangle on the image sensing plane is considered to be solely caused by the inclination of the screen plane with respect to optical axis of the main body. In other words, the calculated values do not represent actual parameters of the attitude of the screen plane on which the first mentioned distorted quadrangle is projected. But, an imaginary parameters are calculated according to an interpretation that the final distorted quadrangle on the image sensing plane would be solely caused by the attitude of the screen plane on which a true rectangle is projected.

More precisely, the main body cannot detect at all whether or not the distorted quadrangle on the image sensing plane is influenced by the inclination of the screen plane with respect to optical axis of the projector. But, the main body carries out the calculation in any case on the interpretation that the image projected on the screen plane is of a true rectangle. Ratio m and ratio n for determining the position of the target point on the screen plane are calculated on the basis of thus calculated attitude.

According to the present invention, however, it is experimentally confirmed that ratio m and n calculated in accordance with the above manner practically represent the position of the target on the original image in the projector as long as such original image is of a true rectangle. In other words, the determination of the target on the original image in the projector is free from the inclination of the optical axis of the projector with respect to the screen plane, which inclination would cause a distorted quadrangle on the screen plane. Therefore, a correct click or drag in the case of the graphic user interface of a computer or a correct shot of a target in the case of shooting game is attained freely from a possible distortion of the image projected on a wide screen.

[Embodiment 3]

In this embodiment, when taking an image of a portion of a displayed image on the given plane(i.e. screen) subject to position detection on which a plurality of characteristic points (marks) are laid out, it is intended that the image is taken so as to include at least four characteristic points and that the position detection is carried out by detecting the coordinate values of the four characteristic marks.

The configuration and operations of the characteristic point detection process, the position calculation process, etc. of Embodiment 3 are basically the same as those of Embodiment 1, but Embodiment 3 differs in that its characteristic point detector by which four marks for position detection are detected from among the plurality of characteristic points and by which those points' coordinate values on the screen coordinate system are determined is improved.

Specifically, the characteristic point detection configuration of this embodiment corresponding to characteristic point detector 511 of FIG. 2 is, in addition to a difference calculator and a binary picture processor, provided with a mark determination means that determines whether a mark is to be selected as a mark for position detection by, after calculating each mark's area and the center of gravity, comparing the mark's area with that of a mark, from among all the marks, nearest to the center of the taken image (i.e., the position to be detected) and further with mark coordinate identifier 514 that identifies the detected four marks' coordinate positions on the entire image on the screen.

First, the layout of the plurality of marks located at predetermined positions and a relevant image display method will be described.

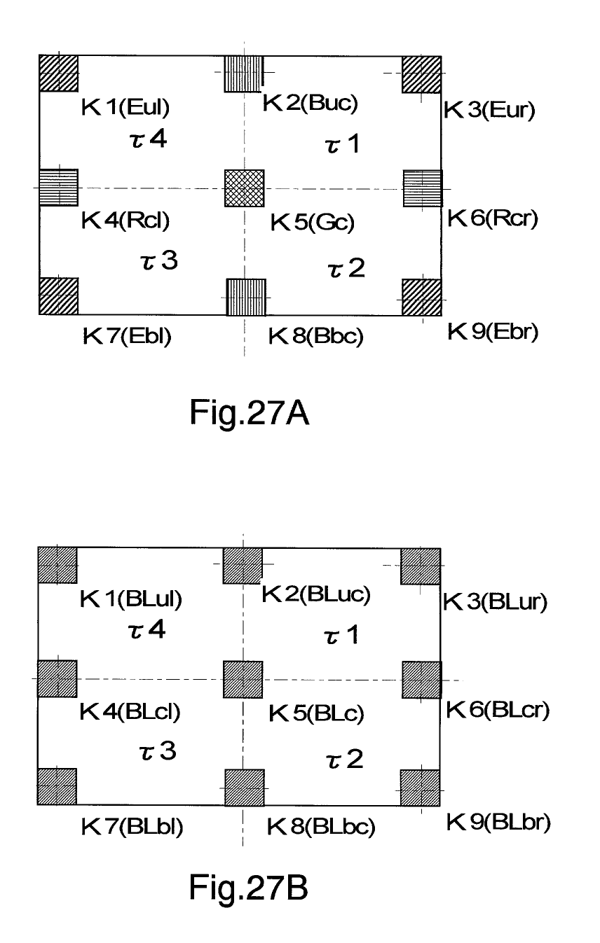

FIGS. 27A and 27B each represent a standard image for position detection provided with a plurality of marks. FIG. 27A represents a first standard image for position detection (a first frame standard image) across which nine quadrangle-shaped marks Kᵢ (i=1, . . . , 9) are laid out in a 3×3 lattice form and by which, from among the plurality of marks, at least four marks defining a rectangle can be taken. In the nine marks' layout of this embodiment, at center position K1 is laid out a G-colred (green) mark; at each of top position K2 and bottom position K8 of the center line is laid out a B-colored (black) mark; at each of left end position K4 and right end position K6 of the center row is laid out a R-colored (red) mark; and at each of four corner positions K1, K2, K3, and K4 is laid out a magenta-colored (E) mark. In the drawing, each of the four displayed image areas is respectively denoted by τ1, τ2, τ3, and τ4.

FIG. 27B represents a second standard image for position detection on which nine marks, all BL-colored (black), are each laid out at a position corresponding to the position of each mark of the first standard image.

It is intended that by sequentially displaying displayed images including the two standard images, by taking the images by a main body of position detector 100 provided with a camera, and then by applying a differential image processing method to the two taken images, plural marks of the above-described marks are exclusively detected.

It is to be noted that the shapes, colors, numbers of, and layout of the laid out marks on the standard images are appropriately determined depending upon the size of a displayed image subject to position detection, the performance of camera lens, camera conditions, etc.

By laying out a plurality of marks at predetermined positions on two standard images in such a manner, taking only a portion of a displayed image including four marks whose positional relationships to the displayed image are known would permit specifying coordinate values of a target subject to position detection on the displayed image, without taking the entirety of the displayed image. At the same time, the positional relationship when the taking was performed of the image plane of the position detector to the displayed image subject to position detection can also be identified.

Such a method can avoid the necessity for using a super-wide-angle lens as a camera lens attached to the camera, and thus costs can be lowered. Further, by elaborating the number of and layout of marks, the method can be applied to various applications without being limited to this embodiment.

The standard images of this embodiment on which a plurality of marks are located are displayed along with a displayed image subject to position detection.

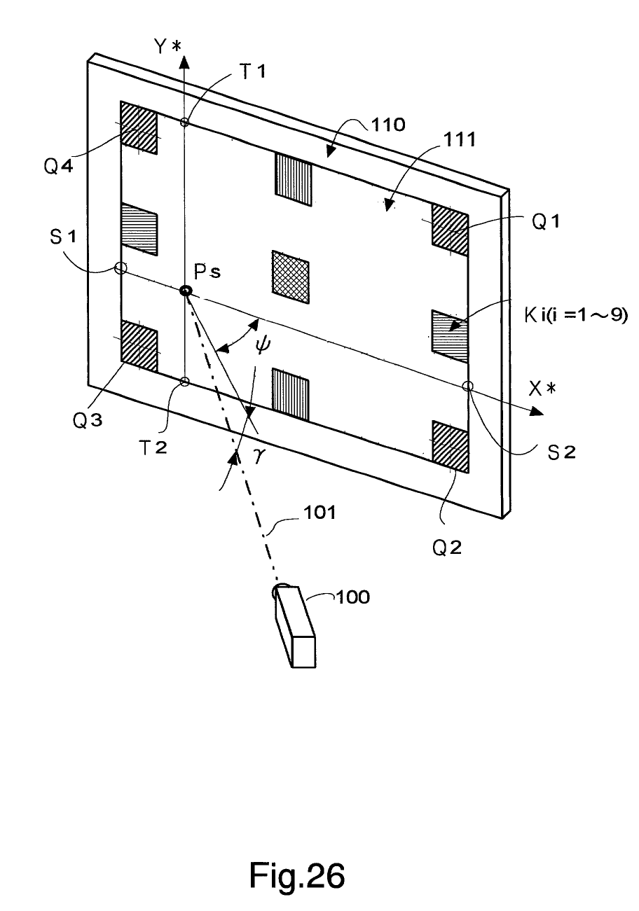

As represented in FIG. 26, standard image K and displayed image 111 subject to position detection, both displayed on the window of a personal computer, are projected on a screen in a superimposed manner by a projector.

It is to be noted that instead of the superimposition, by allotting the displayed image subject to position detection and the standard image to a first window image and a second window image, respectively, the window images may be switched being timed to the camera operations.

Next, the operations of the characteristic point detector by which at least four marks are detected as marks for position detection from among the plurality of marks will be described.

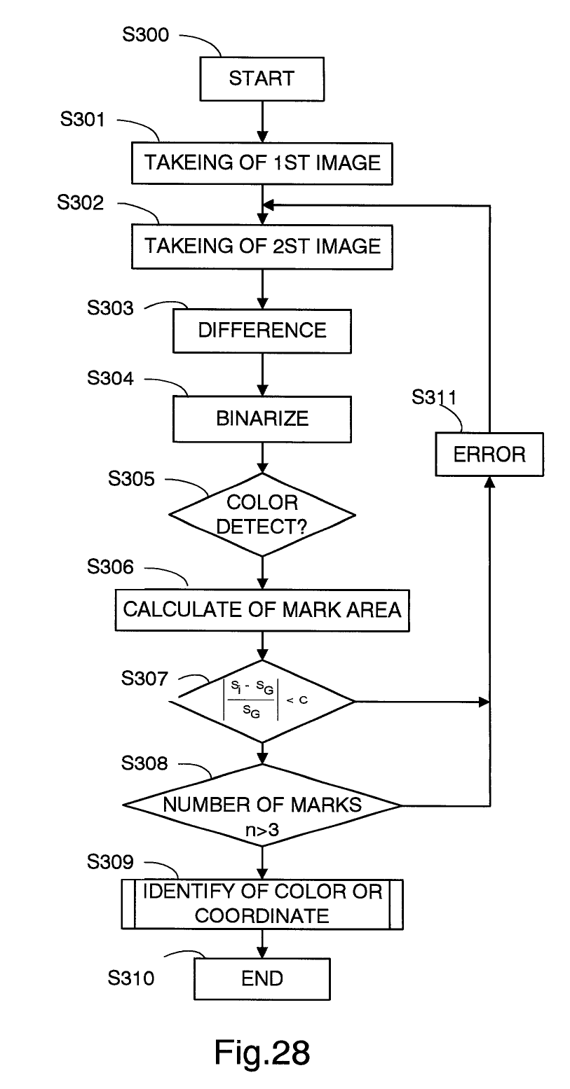

FIG. 28 shows a operation flowchart of the characteristic point detector in which steps from the taking step of the four marks to the color determination and coordinate value identification step of each mark are represented.

At steps S301 and S302, marks in the standard images projected on a screen are captured as taken images. In this embodiment, with a differential image processing method being applied, two frame images each of which has different color or brightness marks are captured by camera, and marks for position detection defining a rectangle are exclusively detected.

At step S301, the first standard image including such marks as described above is captured by a camera; at step S302, the second first standard image including such marks as described above is captured by a camera.

At step S303, the differential image processing method is applied to the captured two taken images; and at step S304, the marks are detected by applying a binary picture process using threshold values predetermined for each R, G, and B colors. After the binary picture process being applied, at step S305, the color and shape of each mark is determined; and at step S306, the area of each mark is calculated to determine the center of gravity thereof.

At step S307, after the area of each mark being calculated at step S306, a mark determination process for determining whether the detected marks can be used as the marks for position detection is performed. When taking a plurality of marks, the entire area of a particular mark may likely not fall within the image field of view. Further, because this embodiment's image plane of the position detector can be positioned at the user's discretion, the detected mark shape is affected by the perspective effect, and thus the apparent area of the mark varies depending upon the position of the camera. To address those problems, the mark determination process of this embodiment uses a method in which with standard to the area (S_{G}) of a mark nearest to the center of the taken image, the ratio of each mark's area (S_{Ki}) to S_{G} is compared with a predetermined ratio (C). By way of example, if Cᵢ (=S_{Ki}/S_{G}) does not exceed 50%, the mark is not regarded as a mark to be detected. Such a method permits determination not affected by the perspective effect accompanying the variable position of the camera.

At step S308, it is determined if four or marks for performing the position detection have been detected. At the next step S309, the center of gravity coordinate values and the color of each mark is identified, as will be described in detail later.

Next, the layout of the mark color identification method will be described. However, detailed description of will be omitted because it is a well-known technique.

When the outputted signals from the camera are video signals, the taken image data are constituted of two taken images that are sequentially taken on successive two frames (1/30 sec. per frame), a first image and a second image with different mark brightness. The composite video signals constituted of image signals and synchronization signals are digitized by an A/D converter, and the digitized RGB output signals or the brightness signal/ the color-difference-signal is generated from the video signals via a matrix decoder (not shown). The color identification process is performed by using one of those signals.

The differential process is applied to the two frame images: the first frame image including R(red)-, G(green)-, B(blue)-, and E(magenta)-colored marks and the second frame image including BL(black)-colored marks.

Next, by applying a binary picture process by using predetermined upper limit and lower limit threshold values Thᵤ and Th_{b} to the differential images obtained for each colors, the marks are detected with respect to each color.

The mark colors of the taken images are apt to be different from the original, predetermined colors due to various problems such as shading, white-balance, color deviation, etc. arising from the projecting device (e.g., projector) and from the camera conditions. In consideration of those various factors, it is preferable that at the time of initial setting of position detection, the upper and lower threshold values can be varied in accordance with the use conditions.

It is to be noted that the position determination is performed by using four-color marks in this embodiment, but as long as the position determination can be enabled, such a plural-color condition can be dispensed with.

Next, the process by which the coordinate values of the four marks for position detection selected from among the detected plural marks are identified will be described.

The detected shapes, areas, numbers of, and the positions of the marks laid out on the standard images are greatly influenced by the camera position relative to the displayed image, the lens specifications, the camera conditions, etc.

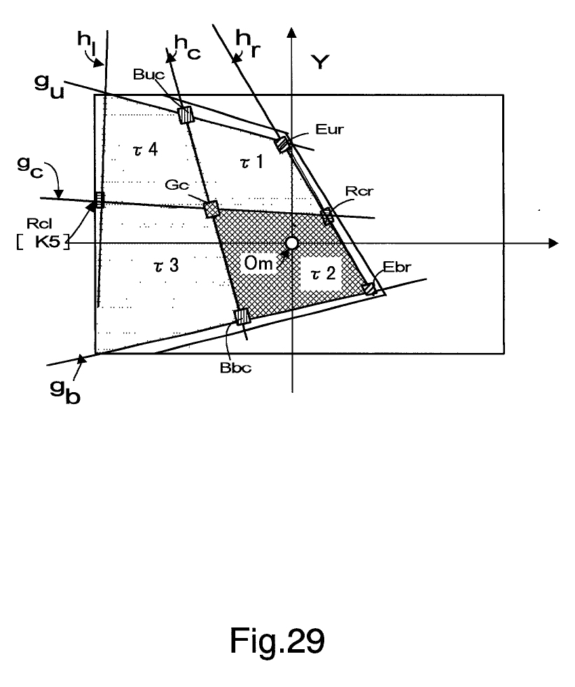

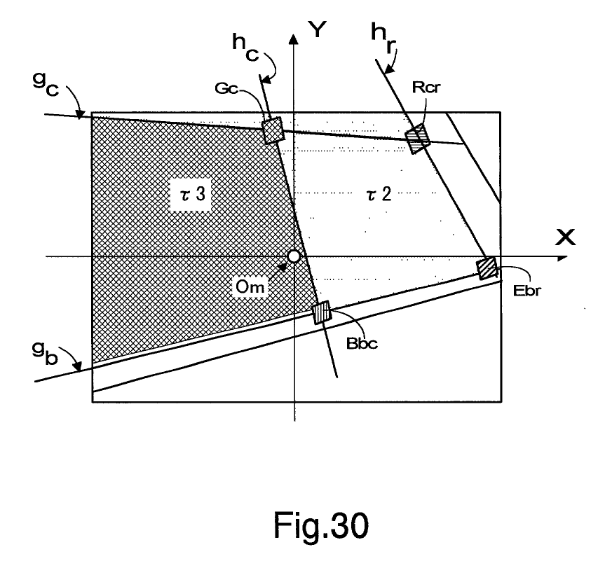

FIGS. 29 and 30 each show a typical taken image example when a portion of a displayed image including a plurality of marks is taken from a particular camera position.

In FIG. 29, the center Om of the image plane as the position to be detected is in displayed image area τ2 of the displayed image; although almost the entire displayed image is in the taken image and although six marks as characteristic points are detected, two marks are not detected at all. The rest one is partially taken. In addition, position to be detected Oₘ is in a region defined by four mark defining a rectangle. In the drawing, lines gᵤ, g_{b}, hᵣ, and hₗ, as the boundary lines separating the displayed image area from the non-displayed image area of the displayed image, that pass the corresponding identified mark centers of gravity are represented.

In contrast, FIG. 30 shows an example in which position to be detected Oₘ lies outside of a region defined by four mark defining a rectangle.

In this embodiment, to detect a position to be detected on a 100-inch wide-screen image, four-color nine mark images, which are constituted of one G-colored mark image, two R-colored mark images, two B-colored mark images, and four E-colored mark images, are displayed. It must be so configured that even when a portion of the wide-screen image is taken, the four marks are surely detected; that to which area of the entire displayed image the taken image corresponds is identified; and that the posture of the main body of the position detector relative to the displayed image when the camera was performed is precisely identified.

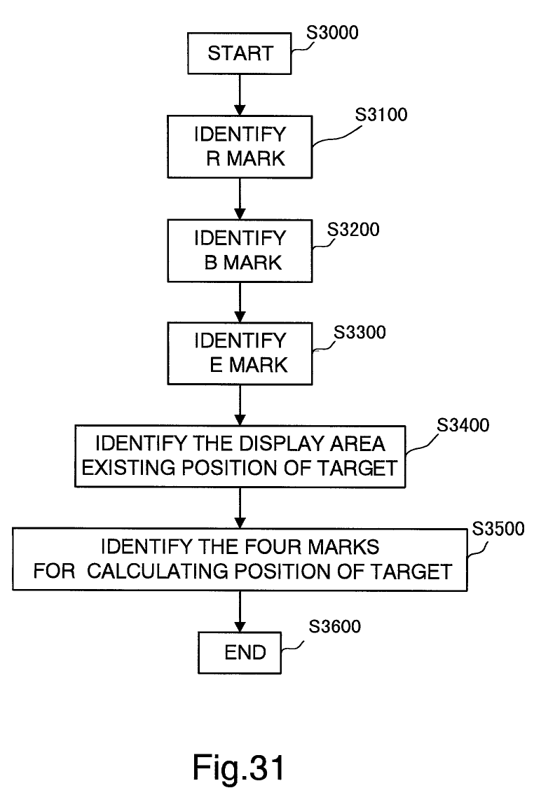

FIG. 31 shows a basic flowchart of the mark identification process for identifying the four marks used for the position calculation.

In this process, when there are, among the marks detected by the mark detection process of FIG. 28, more than one marks having the same color, those marks' corresponding positions on the displayed image are identified. The number of marks detected by the mark detection process of FIG. 28 must be four or more, and the color of at least one mark of those marks must be different from the others.

Because only one G-colored mark is located in the standard image, the mark is detected and its coordinate values are identified through the mark detection process of FIG. 28.

At step S3100, the corresponding position(s) on the displayed image of detected R-mark(s) is (are) identified. Similarly, at the next step S3200, detected B-mark(s) is (are) identified; at step S3300, detected E-mark(s) is (are) identified. The identification processes of those R-, B-, and E-marks will be described later.

At step S3400, it is determined in which displayed image area of the displayed image the center of the taken image as the position to be detected is. In the drawing, four areas defined by four marks out of nine marks displayed in the displayed image are denoted by τ1, τ2, τ3, and τ4.

At step S3500, it is determined which four marks out of a plurality of detected marks are used for calculating the coordinate values of the position to be detected.

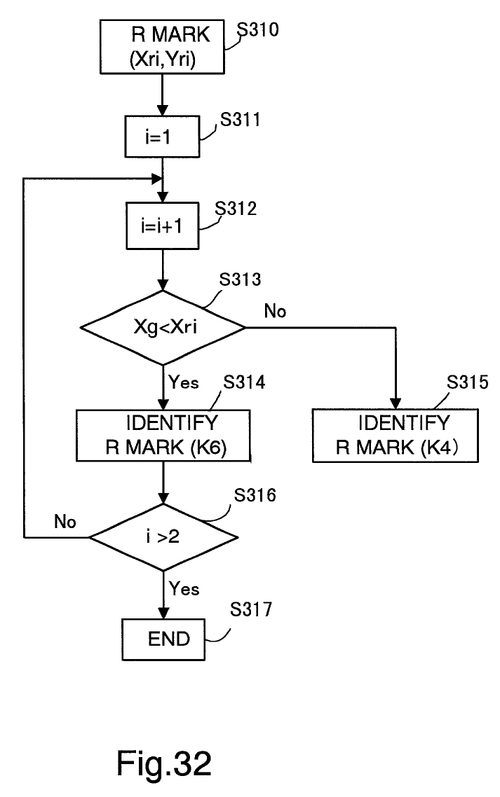

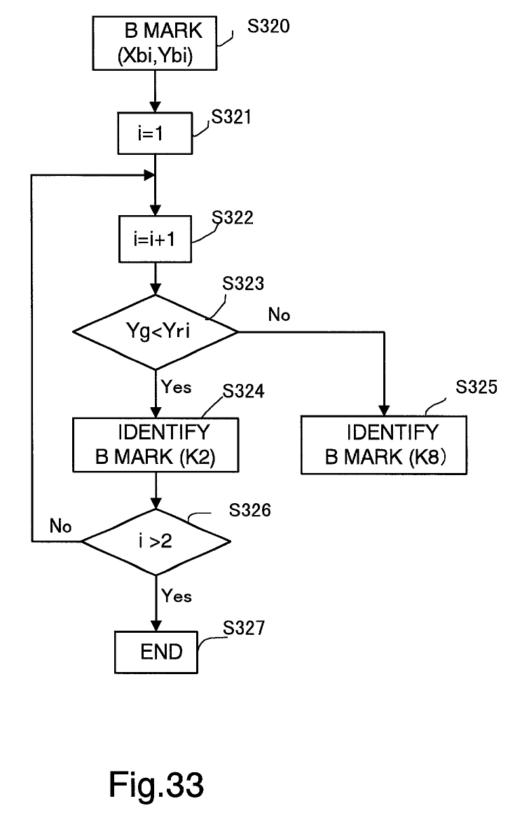

FIGS. 32 and 33 show a flowchart of the R-colored mark identification process and that of the B-colored mark identification process, respectively.

Two R-colored marks are located in the standard image, and in FIG. 32, it is assumed that at least one R-colored mark has been detected and it is identified to which R-colored mark in the standard image the detected R-colored mark corresponds.

The process by which the position on the displayed image of the at least one detected R-colored mark is identified will be described. Assume that two R-colored marks have been detected and that the coordinate values of each mark on the taken image coordinate system is (Xri, Yri), where i=1, 2.

The two R-colored marks are located on a line which is parallel to the X-axis of the screen coordinate system and passes the center of the displayed image. Thus, at step S313, it is determined whether each of the detected R-marks is on the right side of the G-colored mark located on the center of the displayed image or is on the left side thereof with standard to the G-colored mark's X-coordinate value (X_{g}) of its taken image coordinate values (X_{g}, Y_{g}).

If X_{g}<Xri, it is identified at step S314 that the detected R-colored mark corresponds to the R-colored mark of K6; if X_{g}>Xri, it is identified at step S315 that the detected R-colored mark corresponds to the R-colored mark of K4.

FIG. 33 show a flowchart of the B-colored mark identification process for identifying the detected B-colored marks. The two B-colored marks are located on a line which is parallel to the Y-axis of the screen coordinate system and passes the center of the displayed image. Thus, the determination at step S323 is performed it is determined with standard to the G-colored mark's Y-coordinate value (Y_{g}) of its taken image coordinate values (X_{g}, Y_{g}). The other processes are similar to those of the R-marks of FIG. 32, which will be omitted here.

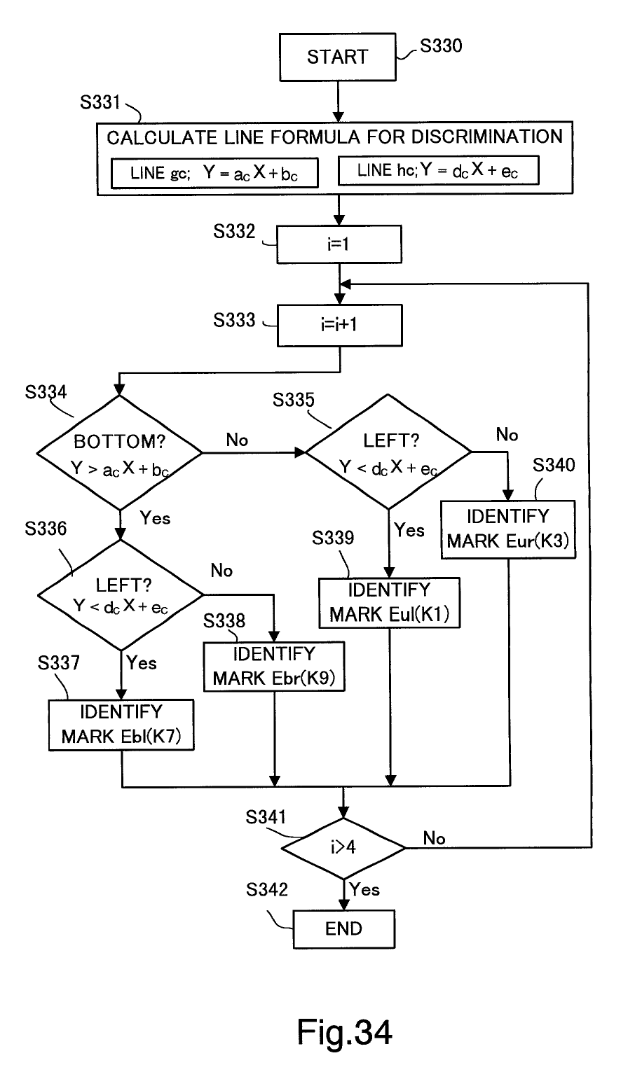

FIG. 34 show a flowchart for identifying to which E-colored mark out of the four E-colored marks each located at each of the four corner positions of the displayed image a detected E-colored mark corresponds.

Assume that the coordinate values of each detected E-colored mark on the taken image coordinate system is (Xei, Yei), where i is the number of the detected E-colored marks.

At step S331, two line equations for the position identification of the E-colored marks are introduced. One of the line equations represents line g_{c} which is parallel to the X-axis of the screen coordinate system and passes the R-colored marks and G-colored mark; the other line represents line h_{c} which is parallel to the Y-axis of the screen coordinate system and passes the B-colored marks and G-colored mark. The position identification of the E-colored marks is performed based on the two equations.

At step S334, it is determined through the identification line gc whether the detected E-colored mark is in the bottom side portion of the displayed image, i.e., whether the mark is on the lower side of line g_{c}. More specifically, the coordinate values (Xei, Yei) of the E-colored mark are substituted into the identification line equation, and if Yei>a_{c}Xei+b_{c} holds, the E-colored mark is regarded to be in the bottom side portion of the displayed image. Next, proceeding to step S336, it is determined through the identification line h_{c} whether the detected E-colored mark is in the right side portion of the displayed image. In other words, if Yei<d_{c}Xei+e_{c} holds, the E-colored mark is regarded to be in the right side portion of the displayed image, i.e., the mark is identified to be mark E_{bl} located at position K7 in displayed image area τ2 of the standard image.

Further, if at step S334, Yei<a_{c}Xei+b_{c} holds, i.e., if it is determined that the mark is in the upper side portion of the displayed image, step S335 is started to determine through the identification line h_{c} whether the mark is in the right side or the left side portion of the displayed image. If Yei<d_{c}Xei+e_{c} holds, i.e., if the E-colored mark is determined to a mark in the upper and left side portion of the displayed image, the mark is identified to be mark Eᵤₗ located at position K1 in the standard image. On the contrary, if Yei>a_{c}Xei+b_{c} holds, i.e., if the E-colored mark is determined to a mark in the upper and right side portion of the displayed image, the mark is identified to be mark E, located at position K3 in the standard image.

Each of the detected R-, B-, and E-colored marks are thus sequentially processed and identified by the above processes.

Next, the process of step S304 of FIG. 31, by which in which displayed image area of the displayed image the position to be detected is determined, will be described.

In this embodiment, the position to be detected in the displayed image is detected as the center of the taken image, and the position calculation of the position is performed using a image coordinate system of which origin om (0, 0) is the center of the image plane. Thus, the process by which in which displayed image area of the displayed image the origin is determined can be implemented by using the same flowchart as used in FIG. 34 for identifying the position on the displayed image of an E-colored mark.

The position identification in this case is performed by substituting the origin's coordinate values (0, 0) into the line equations of step S331. For example, step S337 by which E_{bl} (K7) is identified is applied also to the process by which a position to be detected is identified to be in displayed image area τ3, in which K7 is. The position in the displayed image of the taken center as the position to be detected is thus identified.

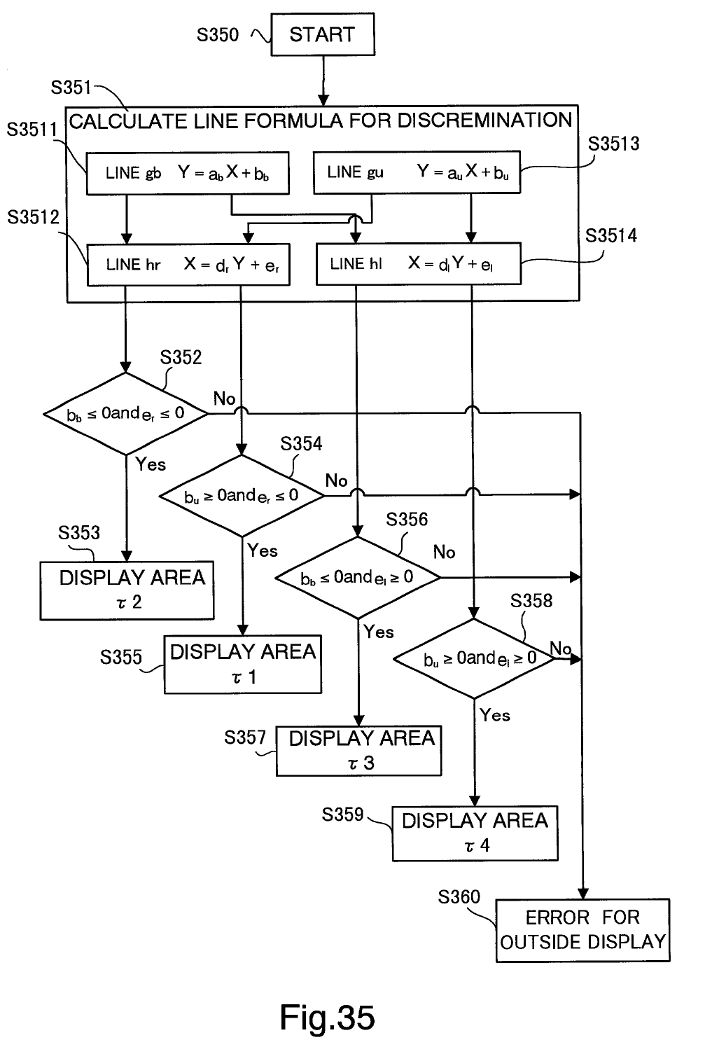

Then followed previous process, the process by which whether the center of the taken image, the position to be detected, is in the displayed image is determined will be described referring to FIG. 35.

At step S351, line equations g_{b} and gᵤ that define the boundary lines of the effective displayed image and are parallel to the X-axis of the screen coordinate system of the displayed image and line equations hᵣ and hₗ that define the boundary lines of the effective displayed image and are parallel to the Y-axis of the screen coordinate system are calculated based on the coordinate values of the plurality of identified marks.

It is determined whether the position to be detected is in the displayed image based on the four line equations.

At step S352, discrimination conditions b_{b}≦0 and eᵣ≦0 determine that the position is in displayed image area τ2; if not, at step S306, an error message or a warning beep is given to proceed to a process to capture the image again by a camera.

At step S354, it is determined by the use of discrimination line equations gᵤ and hᵣ whether the position is in displayed image area τ1; at step S356, it is determined by the use of discrimination line equations g_{b} and hₗ whether the position is in displayed image area τ3; at step S358, it is determined by the use of discrimination line equations gᵤ and hₗ whether the position is in displayed image area τ4.

Next, the process by which the four marks for calculating the coordinate values of the position to be detected are identified will be described.

In this embodiment, identification of four marks constituted of one G-colored mark, one R-colored mark, one B-colored mark, and one E-colored mark would permit detection of the posture of the displayed image relative to the image plane and identification of the position of the position to be detected. In other words, extraction of a single displayed image area from among τ1, τ2, τ3, and τ4, each defined by a set of one G-colored mark, one R-colored mark, one B-colored mark, and one E-colored mark, would suffice for the identification. Even when, as shown in FIG. 30, the position to be detected is in displayed image area τ3 and the four mark defining τ3 are not detected, the position calculation of the position to be detected can be performed as long as the four mark defining τ2 are detected.

As described in the above, by locating the marks at the lattice points in the displayed image, the coordinate values of the point to be detected can be identified even from a restricted image area without taking the entire displayed image. Also, by elaborating the colors, shapes, etc. of the marks, the vertical location of the taken image captured by the position detector can be determined, and the operability thereof is greatly enhanced. Further, the specifications of the camera lens can be relaxed, and thus costs can also be lowered.

<Position Calculation>

Next, the position calculation process of the position to be detected on the displayed image of this embodiment will be described.

The coordinate value calculation of the position to be detected Pₛ of this embodiment is performed in a similar manner to that described in Embodiment 1, except that the correction of the detected mark positions is required because only a portion out of the entire displayed image is taken.

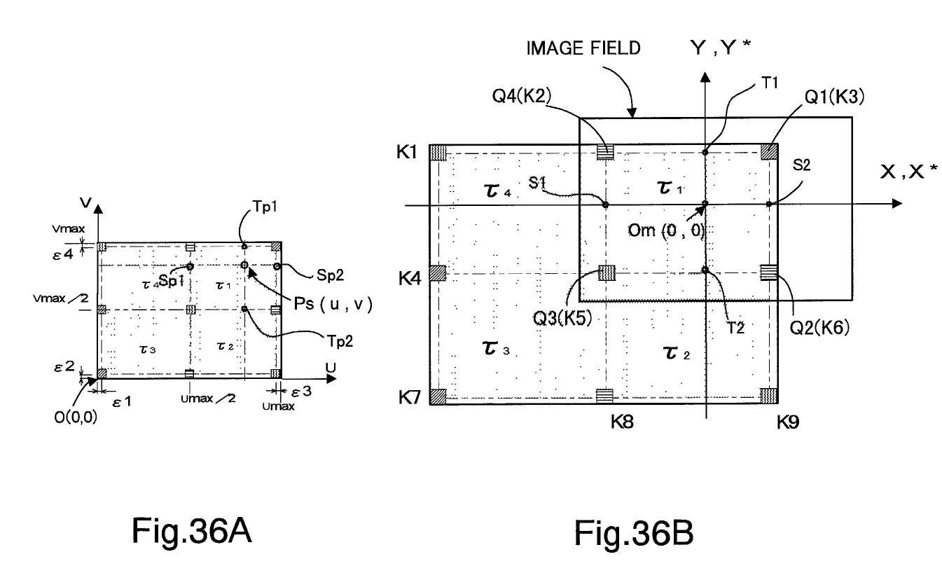

FIG. 36 represents the positional relationship between the marks displayed on the screen image as the image to be taken and the marks displayed on the personal computer as the original image and corresponds to FIG. 18 of Embodiment 1.

FIG. 36A represents the original personal computer image displayed on the U-V coordinate system; FIG. 36B represents the projected screen image displayed on the X*-Y* coordinate system. In FIG. 36B, on the entire screen image constituted of the orthogonal projected image of the original personal computer image is represented image area q, displayed on the X-Y coordinate system, constituted of the portion of the screen image to be taken in front thereof. In the drawing, because the image plane of the position detector was positioned in front of the screen plane (elevation angle=0, depression angle=0) when the camera was taken, the X-Y taken image coordinate system and the X*-Y* screen coordinate system are aligned with each other. Further, the plurality of marks as standard images are superimposed on the image subject to position detection on which the position to be detected lies.

The screen image coordinate system is expressed by the X*-Y* coordinate system; the taken image coordinate system is expressed by the X-Y coordinate system. The center position of the taken image, Oₘ, of the position detector of this embodiment is position to be detected Pₛ (X*ᵢ, Y*ᵢ) on the screen coordinate system. The taken image corresponds to a portion of the entire displayed image, and displayed image area τ1 is identified through the coordinate values and colors of the four taken marks Q1 (K3), Q2 (K6), Q3 (K5), and Q4 (K2).

FIG. 36B represents the original personal computer image projected on the screen by a projector. The coordinate system in the drawing is expressed by the cursor coordinate system (U-V coordinate system). The four marks K3, K6, K5, and K2 in FIG. 36A are expressed by Q1, Q2, Q3, and Q4, respectively. The screen coordinate system (X*-Y* coordinate system) and the cursor coordinate system (U-V coordinate system) are associated with each other; and thus, with Pₛ (X*ᵢ, Y*ᵢ)=Pₛ (Uᵢ, Vᵢ) being the case, the coordinate values of the position to be detected can be expressed by:

$${P}_{s} ( U , V ) = ( \frac{2 m + 1}{m + 1} \cdot \frac{{U}_{max}}{2} - \frac{m}{m + 1} \cdot {ϵ}_{3} , \frac{n + 2}{n + 1} \cdot \frac{{V}_{max}}{2} - \frac{1}{n + 1} \cdot {ϵ}_{4} ) \qquad ( 28 )$$

Since the center positions of gravity of the marks located at the four corner positions of this embodiment deviate from the U- and V-axes by ε1, ε 2, ε3, and ε4, those deviations are cancelled when calculating the coordinate values of the position to be detected.

As described above, according to this embodiment, the position of the position to be detected can be easily calculated from the mark's image data when a rectangular potion of the displayed image defined by a minimum set of marks is taken without taking all the marks located in the displayed standard images in the three-dimensional space. Thus, by determining the minimum lattice unit defining a rectangle depending upon the size of a displayed image, the applicability of the position detector of the invention can be greatly enhanced, and the specifications of the camera lens can also be relaxed.

In addition, according to this embodiment, the position detection can be performed by the position detector, with a simplified device configuration, positioned at any position relative to the displayed image; and thus, the position detection can be performed with respect to the displayed image directly projected on a screen without providing light-emitting devices on the predetermined positions on the displayed image subject to position detection.

What is claimed is:

1. A position detector for detecting a position of a target point on a given plane having a plurality of characteristic points, the number of which is greater than a predetermined number, comprising:
an image sensor having an image plane on which an image of the given plane is formed with at least the predetermined number of the characteristic points included in the image, a point of the image which is formed at a predetermined position of the image plane corresponding to the target point to be located on the given plane;
an image processor that identifies the positions of the characteristic points on the image plane; and
a processor that calculates the position of the target point on the basis of the identified positions of the predetermined number of the characteristic points on the image plane.

2. The position detector according to claim 1 further comprising a controller that generates the plurality of characteristic points on the given plane, the number of which is greater than the predetermined number.

3. The position detector according to claim 2, wherein the controller adds, to a display on the given plane, the plurality of characteristic points as a known standard.

4. The position detector according to claim 2, wherein the controller generates a first display and the plurality of characteristic points as a second display with the relative positions between both the displays predetermined, wherein an image of the first display and an image of the second display are capable of being formed on the image plane of the image sensor, a point in the image of the first display which is formed at a predetermined position of the image plane corresponding to the target point to be located on the given plane, and wherein the processor calculates the position of the target point on the basis of the position of the second display on the image plane identified by the image processor.

5. The position detector according to claim 2, wherein the controller includes a projector for projecting an image including the characteristic points on the given plane.

6. The position detector according to claim 2, wherein the given plane is a display controlled by a computer, and wherein the function of the controller is included in the computer.

7. The position detector according to claim 1, wherein the predetermined number is four.

8. The position detectors according to claim 7, wherein the four characteristic points are arranged to be the corners of a rectangle.

9. The position detector according to claim 1, wherein the characteristic points are arranged to be crossing points of a grid.

10. The position detector according to claim 1, wherein the image processor is arranged to identify the positions of the characteristic points on the image plane with at least one of the characteristic points distinguished from the others.

11. The position detector according to claim 1, wherein the image processor includes a calculator that calculates a difference in the output of the image sensor between a first condition with the characteristic points on the given plane and a second condition with the given plane in a reference state to identify the positions of the characteristic points.

12. The position detector according to claim 1, wherein the image processor includes a trigger that causes the identification of the positions of the characteristic points with the image of the target point formed at the predetermined position of the image plane.

13. A position detector for detecting a position of a target point in a display on a given plane comprising:
a controller that adds a known standard to the display on the given plane;
an image sensor having an image plane on which an image of the display on the given plane is formed with an image of the standard included, a point in the image of the display which is formed at a predetermined position of the image plane corresponding to the target point to be located in the display on the given plane;
an image processor that identifies the image of the standard on the image plane;
a processor that calculates the position of the target point on the basis of the identified image of the standard on the image plane.

14. A position detector for detecting a position of a target point on a given plane comprising:
a controller that generates a first display and a second display on the given plane with the relative positions between both the displays predetermined;
an image sensor having an image plane on which an image of the first display and an image of the second display are capable of being formed, a point in the image of the first display which is formed at a predetermined position of the image plane corresponding to the target point to be located on the given plane;
an image processor that identifies the image of the second display on the image plane;
a processor that calculates the position of the target point on the basis of the identified image of the second display on the image plane.

15. A position detector for detecting a position of a target point on a given plane having a plurality of characteristic points comprising:
an image sensor having an image plane on which an image of the given plane is formed with the characteristic points included in the image, a point of the image which is formed at a predetermined position of the image plane corresponding to the target point to be located on the given plane;
an image processor that identifies the positions of the characteristic points on the image plane, the image processor identifying the positions with at least one of the characteristic points distinguished from the others; and
a processor that calculates the position of the target point on the basis of the identified positions of the characteristic points on the image plane.

16. The position detector according to claim 15, wherein the processor includes a decider that decides a way of calculating the position of the target point among possible alternatives on the basis of the position of the at least one characteristic point distinguished from the others.

17. A position detector for detecting a position of a target point on a given plane comprising:
a controller that generates a plurality of characteristic points on the given plane, at least one of the characteristic points being distinguished from the others;
an image sensor having an image plane on which an image of the given plane is formed with the characteristic points included in the image, a point of the image which is formed at a predetermined position of the image plane corresponding to the target point to be located on the given plane;
an image processor that identifies the positions of the characteristic points on the image; and
a processor that calculates the position of the target point on the basis of the identified positions of the characteristic points on the image plane.

18. The position detector according to claim 17, wherein the controller includes a generator that generates the at least one characteristic point of a color different from those of the others.

19. The position detector according to claim 17, wherein the controller includes a generator that generates the plurality of characteristic points of at least red, green and blue.

20. The position detector according to claim 17, wherein the controller includes a generator that generates the plurality of characteristic points classifiable into at least four distinguishable types.

21. A position detector for detecting a position of a target point on a given plane having a plurality of characteristic points comprising:
an image sensor having an image plane on which an image of the given plane is formed with the characteristic points included in the image, a point of the image which is formed at a predetermined position of the image plane corresponding to the target point to be located on the given plane;
an image processor that identifies the positions of the characteristic points on the image, the image processor including a calculator that calculates a difference in the output of the image sensor between a first condition with the characteristic points on the given plane and a second condition with the given plane in a reference state to identify the positions of the characteristic points; and
a processor that calculates the position of the target point on the basis of the identified positions of the characteristic points on the image plane.

22. The position detector according to claim 21 further comprising a controller that generates the plurality of characteristic points on the given plane and also generates the reference state of the given plane in place of the plurality of characteristic points.

23. The position detector according to claim 22, wherein the controller is arranged to make the given plane into the reference state at the same positions as those of the characteristic points.

24. A position detector for detecting a position of a target point on a given plane having a plurality of characteristic points comprising:
an image sensor having an image plane on which an image of the given plane is formed with the characteristic points included in the image, a point of the image which is formed at a predetermined position of the image plane corresponding to the target point to be located on the given plane;
an image processor that identifies the positions of the characteristic points on the image, the image processor includes a trigger that causes the identification of the positions of the characteristic points with the image of the target point formed at the predetermined position of the image plane; and
a processor that calculates the position of the target point on the basis of the identified positions of the characteristic points on the image plane.

25. The position detector according to claim 24 further comprising a controller that generates the plurality of characteristic points on the given plane in synchronism with the trigger.

26. An attitude detector for detecting an attitude of a given plane comprising:
a trigger;
a controller that generates a plurality of characteristic points on the given plane in synchronism with the trigger;
an image sensor having an image plane on which an image of the given plane is formed with the characteristic points included in the image;
an image processor that identifies the positions of the characteristic points on the image, the identification of the positions of the characteristic points being caused in synchronism with the trigger;
a processor that calculates the attitude of the given plane on the basis of the identified positions of the characteristic points on the image plane.
